(19) United States
(12) Patent Application Publication
(10) Pub. No.: US 2025/0377271 A1
(43) Pub. Date: Dec. 11, 2025

(54) ENHANCED SEDIMENTATION MODULES AND SYSTEM FOR IMPROVED CELL CONCENTRATION

(71) Applicant: OCTANE BIOTECH INC., Kingston (CA)

(72) Inventor: Peter SZARAZ, Kingston (CA)

(21) Appl. No.: 19/227,755

(22) Filed: Jun. 4, 2025

Related U.S. Application Data
(60) Provisional application No. 63/658,588, filed on Jun. 11, 2024.
(60) Provisional application No. 63/752,917, filed on Feb. 3, 2025.

(51) Int. Cl. G01N 1/40

(52) U.S. Cl. CPC G01N 1/40

(57) ABSTRACT

Systems, methods, and devices for particle separation are provided. A cell sedimentation module may include a housing, which may include a cell sedimentation vessel disposed within the housing, the cell sedimentation vessel having sidewalls, a bottom surface, and a cell collection well formed into the bottom surface. The sedimentation module may include a first flow line configured for input of a cell suspension and output of a supernatant. The sedimentation module may include a second flow line configured for output of a target cell suspension, wherein the cell sedimentation vessel is configured to non-mechanically generate a centripetal flow therein to facilitate separation of the supernatant and the target cell suspension from the cell suspension. In embodiments, the cell sedimentation module may incorporate multiple stacked vessels. In alternative embodiments, the cell sedimentation module may include at least one insert disposed therein to facilitate separation of supernatant and target cell suspension.

### FIELD OF THE INVENTION

The present disclosure relates to improved sedimentation modules, systems, and methods for particle separation designed for integration into automated fluidics systems.

### BACKGROUND

Volume reduction and concentration processes are a necessary and high-demand element of a cell production process. The equipment applied is expected to achieve high efficiency cell enrichment in a rapid manner without compromising product quality.

The currently available technologies require devices with low feasibility for integration into compact cell production systems, such as those based on centrifugation and filtration methods. Some technologies, for example, use counterflow centrifugation for cell separation. Other technologies use tangential flow filtration, while standalone upstream and downstream processing equipment use pressurized tangential flow filtration for cell suspension fractionation. For particle filtration purposes depth filtration devices are available, however they are designed for processing large volumes with low particle concentrations. Further technologies may apply the hydrocyclone effect, though this requires a high energy flow stream that generates forces comparable to centrifugation. This approach generates extensive shear that has the potential to reduce product quality.

There is therefore a need for a device to achieve a rapid and efficient particle enrichment process and that can be integrated into a cell production system.

### SUMMARY OF THE INVENTION

In some aspects, the techniques described herein relate to a cell sedimentation module including: a housing; a cell sedimentation vessel disposed within the housing, the cell sedimentation vessel having sidewalls, a bottom surface, and a cell collection well formed into the bottom surface; a first flow line configured for input of a cell suspension and output of a supernatant; and a second flow line configured for output of a target cell suspension; wherein the cell sedimentation vessel is configured to non-mechanically generate a centripetal flow therein to facilitate separation of the supernatant and the target cell suspension from the cell suspension.

In some aspects, the techniques described herein relate to a sedimentation system, including: a cell sedimentation module having a housing for containing a cell sedimentation vessel therein, the cell sedimentation vessel having sidewalls, a bottom surface, and a cell collection well formed into the bottom surface; a first flow line configured for input flow of a cell suspension into the cell sedimentation vessel and output flow of a supernatant from the cell sedimentation vessel, wherein the input flow non-mechanically generates a centripetal flow within the cell sedimentation vessel to facilitate separation of the cell suspension into the supernatant on the bottom surface and a target cell suspension in the cell collection well; and a second flow line configured for output flow of the target cell suspension collected in the cell collection well of the cell sedimentation vessel.

In some aspects, the techniques described herein relate to a method for collecting a target cell suspension from a cell suspension, including: introducing the cell suspension into a cell sedimentation vessel via a first flow line; generating a centripetal flow within the cell sedimentation vessel to facilitate separation of the cell suspension into a supernatant and the target cell suspension; collecting the supernatant near a bottom surface of the cell sedimentation vessel; collecting the target cell suspension in a collection well formed in the bottom surface of the cell sedimentation vessel; flowing the supernatant out of the cell sedimentation vessel via the first flow line; and flowing the target cell suspension collected in the collection well out of the cell sedimentation vessel via a second flow line.

In some aspects, the techniques described herein relate to a cell sedimentation module including: a housing; a multi-level cell sedimentation vessel disposed within the housing, the multi-level cell sedimentation vessel including a plurality of vessels sequentially oriented related to each other, each of the plurality of vessels having sidewalls, a bottom surface, and a cell collection well formed into the bottom surface of at least one of the plurality of vessels; at least one first flow line configured for input of a cell suspension into at least one of the plurality of vessels, and output of a supernatant from at least one of the plurality of vessels; and at least one second flow line configured for output of a target cell suspension from the cell collection well formed into the bottom surface of the at least one of the plurality of vessels.

In some aspects, the techniques described herein relate to a cell sedimentation module including: a housing; a cell sedimentation vessel disposed within the housing, the cell sedimentation vessel having sidewalls, a bottom surface, and a cell collection well formed into the bottom surface; a press filter disposed within the cell sedimentation vessel, the press filter having a substantially conical shape with a plurality of openings disposed thereon to allow for flow of a cell suspension therethrough; a first flow line configured for input of the cell suspension and output of a supernatant; and a second flow line configured for output of a target cell suspension; wherein the cell sedimentation vessel and the press filter are configured to non-mechanically generate a centripetal flow therein to facilitate separation of the supernatant and the target cell suspension from the cell suspension.

In some aspects, the techniques described herein relate to a cell sedimentation module including: a housing; a cell sedimentation vessel disposed within the housing, the cell sedimentation vessel having sidewalls, a bottom surface, and a cell collection well formed into the bottom surface; an insert disposed within the cell sedimentation vessel; and wherein the insert facilitates separation of a supernatant and a target cell suspension from a cell suspension.

In some aspects, the techniques described herein relate to a method for collecting a target cell suspension from a cell suspension, including: inserting an insert into a cell sedimentation vessel; introducing the cell suspension into the cell sedimentation vessel via a first flow line; facilitating separation of the cell suspension into a supernatant and the target cell suspension by flowing the cell suspension over a surface of the insert within the cell sedimentation vessel; collecting the supernatant within the cell sedimentation vessel; settling the target cell suspension in a collection well formed in a bottom surface of the cell sedimentation vessel; flowing the supernatant out of the cell sedimentation vessel via the first flow line; and flowing the target cell suspension collected in the collection well out of the cell sedimentation vessel via a second flow line.

### BRIEF DESCRIPTION OF THE DRAWINGS

The following description of typical aspects described herein will be better understood when read in conjunction with the appended drawings. For the purpose of illustrating the invention, there are shown in the drawings aspects which are presently typical. It should be understood, however, that the invention is not limited to the precise arrangements and instrumentalities of the aspects shown in the drawings. It is noted that like reference numerals refer to like elements across different embodiments as shown in the drawings and referred to in the description.

FIG. 1 illustrates two embodiments of a cell sedimentation module for implementation with a cell sedimentation system as further described herein.

FIG. 2A illustrates a cell sedimentation vessel of an embodiment of a cell sedimentation module as further described herein.

FIG. 2B illustrates a cell sedimentation vessel of another embodiment of a cell sedimentation module as further described herein.

FIG. 3 illustrates how a cylindrical embodiment of a cell sedimentation vessel is formed, using a conical embodiment of a cell sedimentation vessel as further described herein.

FIG. 4A illustrates how tilting a conical embodiment of a cell sedimentation vessel decreases settling distance.

FIG. 4B illustrates how centripetal forces are generated within a cylindrical embodiment of a cell sedimentation vessel.

FIG. 5A illustrates a cylindrical embodiment of a cell sedimentation vessel as described herein.

FIG. 5B illustrates another cylindrical embodiment of a cell sedimentation vessel as described herein.

FIG. 5C illustrates yet another cylindrical embodiment of a cell sedimentation vessel as described herein.

FIG. 6A illustrates how centripetal forces are generated within a cylindrical embodiment of a cell sedimentation vessel as described herein.

FIG. 6B illustrates how centripetal forces are generated within a conical embodiment of a cell sedimentation vessel as described herein.

FIG. 7 illustrates how sediment and target cells are separated within a centripetal flow implemented in the embodiments of the cell sedimentation modules described herein.

FIG. 8A illustrates an embodiment of input flow line and output flow line configurations in a cylindrical embodiment of a cell sedimentation vessel as further described herein.

FIG. 8B illustrates another embodiment of input flow line and output flow line configurations in a cylindrical embodiment of a cell sedimentation vessel as further described herein.

FIG. 9A illustrates yet another embodiment of input flow line and output flow line configurations in a cylindrical embodiment of a cell sedimentation vessel as further described herein.

FIG. 9B illustrates still another embodiment of input flow line and output flow line configurations in a cylindrical embodiment of a cell sedimentation vessel as further described herein.

FIG. 9C illustrates yet another embodiment of input flow line and output flow line configurations included with a silicone-lined bottom surface in a cylindrical embodiment of a cell sedimentation vessel as further described herein.

FIG. 10A illustrates an embodiment of an input flow line, an output flow line, and a tangential flow filter integrated therewith in a cylindrical embodiment of a cell sedimentation vessel as further described herein.

FIG. 10B illustrates another embodiment of an input flow line, an output flow line, and a tangential flow filter integrated therewith in a cylindrical embodiment of a cell sedimentation vessel as further described herein.

FIG. 11A illustrates an embodiment of a sedimentation module configured with a multi-level cell sedimentation vessel.

FIG. 11B illustrates a perspective view of the multi-level cell sedimentation vessel of FIG. 11A.

FIG. 12A is a diagram of an embodiment of the multi-level cell sedimentation vessel as further described herein.

FIG. 12B is a diagram of another embodiment of the multi-level cell sedimentation vessel as further described herein.

FIG. 13 is a diagram of multiple embodiments of a multi-level cell sedimentation vessel for implementation with a sedimentation module as further described herein.

FIG. 14A illustrates another embodiment of a multi-level cell sedimentation vessel as further described herein.

FIG. 14B illustrates another view of the multi-level cell sedimentation vessel of FIG. 14A.

FIG. 15A is a diagram of the multi-level cell sedimentation vessel of FIG. 14A.

FIG. 15B is a side cross-sectional view of the multi-level cell sedimentation vessel of FIG. 14A.

FIG. 15C is another side cross-sectional view of the multi-level cell sedimentation vessel of FIG. 14A.

FIG. 16 is another diagram of the multi-level cell sedimentation vessel of FIG. 14A depicting flow within the multi-level cell sedimentation vessel.

FIG. 17 illustrates progressive primary flow separation into sediment and supernatant in a multi-level cell sedimentation vessel according to the embodiments described herein.

FIG. 18A is a side elevational view of a press filter and cell collection well for implementation in an embodiment of a sedimentation module as further described herein.

FIG. 18B is a bottom-up view of the press filter of FIG. 18A.

FIG. 18C is a bottom-up view of the press filter and cell collection well of FIG. 18A.

FIG. 18D is a top-down view of the press filter and cell collection well of FIG. 18A.

FIG. 19 illustrates a flowchart depicting a method for collecting a target cell suspension.

FIG. 20 illustrates test results measuring secondary flow retention using embodiments of the cell sedimentation vessel and methods described herein.

FIG. 21A illustrates of an insert for a cell sedimentation vessel, the insert configured to facilitate particle separation.

FIG. 21B illustrates a side transparent view of the insert of FIG. 21A

FIG. 22A illustrates a top-down view of the insert of FIG. 21A disposed within a cell sedimentation vessel.

FIG. 22B illustrates a side view of a collection well of the cell sedimentation vessel having the insert of FIG. 21A disposed therein.

FIG. 23A illustrates an embodiment of an insert for a cell sedimentation vessel.

FIG. 23B illustrates another embodiment of an insert for a cell sedimentation vessel.

FIG. 24 illustrates further viewpoints of the insert of FIG. 23B.

FIG. 25 illustrates still another embodiment of an insert for a cell sedimentation vessel.

FIG. 26 illustrates another embodiment of an insert for a cell sedimentation vessel.

FIG. 27 illustrates further embodiments of various inserts for cell sedimentation vessels, shown across a scale of increasing cross-section surface coverage.

FIG. 28 illustrates a helical insert for a cell sedimentation vessel.

FIG. 29 illustrates a side view of the helical insert of FIG. 28 disposed in a cell sedimentation vessel.

FIG. 30A illustrates a bottom-up view of the helical insert of FIG. 28.

FIG. 30B illustrates a top-down view of the helical insert of FIG. 28.

FIG. 30C illustrates a side view of the helical insert of FIG. 28.

FIG. 31 illustrates a spiral insert disposed in a cell sedimentation vessel.

FIG. 32 illustrates multiple embodiments of spiral inserts configured for inserting into a cell sedimentation vessel.

FIG. 33A illustrates a lamella insert for a cell sedimentation vessel.

FIG. 33B illustrates the lamella insert of FIG. 33A disposed within a cell sedimentation vessel.

FIG. 34 illustrates a flowchart depicting a method for collecting a target cell suspension using the various insert embodiments described herein.

### DETAILED DESCRIPTION OF THE INVENTION

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

Unless otherwise defined herein, scientific and technical terms used in the present disclosure shall have the meanings that are commonly understood by one of ordinary skill in the art. Further, unless otherwise required by context, singular terms shall include pluralities, and plural terms shall include the singular.

The articles “a” and “an” are used herein to refer to one or to more than one (i.e., to at least one) of the grammatical object of the article. By way of example, “an element” means one element or more than one element.

The terms “invention” or “present invention” are non-limiting terms and are not intended to refer to any single aspect of the particular invention, but encompass all possible aspects as described in the specification and the claims.

The use of the term “or” in the claims is used to mean “and/or,” unless explicitly indicated to refer only to alternatives or the alternatives are mutually exclusive, although the disclosure supports a definition that refers to only alternatives and “and/or.”

As used herein, the terms “comprising” (and any variant or form of comprising, such as “comprise” and “comprises”), “having” (and any variant or form of having, such as “have” and “has”), “including” (and any variant or form of including, such as “includes” and “include”) or “containing” (and any variant or form of containing, such as “contains” and “contain”) are inclusive or open-ended and do not exclude additional, unrecited, elements or method steps.

The use of the term “for example” and its corresponding abbreviation “e.g.” means that the specific terms recited are representative examples and embodiments of the disclosure that are not intended to be limited to the specific examples referenced or cited unless explicitly stated otherwise.

As used herein, “about” can mean plus or minus 10% of the provided value. Where ranges are provided, they are inclusive of the boundary values. “About” can additionally or alternately mean either within 10% of the stated value, or within 5% of the stated value, or in some cases within 2.5% of the stated value; or, “about” can mean rounded to the nearest significant digit.

As used herein, the terms “close”, “approximate”, and “practically” denote a respective relation or measure or amount or quantity or degree that has no adverse consequence or effect relative to the referenced term or embodiment or operation of the scope of the invention.

As used herein, “between” is a range inclusive of the ends of the range. For example, a number between x and y explicitly includes the numbers x and y and any numbers that fall within x and y.

As may be used herein any terms referring to geometrical relationships such as “vertical”, “horizontal”, “opposite”, “straight”, “lateral”, “parallel”, “perpendicular”, and other angular relationships denote also approximate yet functional and/or practical, respective relationships.

As may be used herein, the terms “preferred”, “preferably”, “typical”, “typically”, or “optionally” do not limit the scope of the invention or embodiments thereof.

As may be used herein, the term “biological sample” may be any material derived from a human or other organism, including a mammal. As described herein, a biological sample may comprise a body fluid sample, a body cell sample, an in-vitro cell sample, a genetically engineered cell sample, or a biological tissue sample. Examples of biological samples include urine, lymph, blood, plasma, serum, saliva, cervical fluid, cervical-vaginal fluid, vaginal fluid, breast fluid, breast milk, synovial fluid, semen, seminal fluid, stool, sputum, cerebral spinal fluid, tears, mucus, interstitial fluid, follicular fluid, amniotic fluid, aqueous humor, vitreous humor, peritoneal fluid, ascites, sweat, lymphatic fluid, lung sputum and lavage or samples derived therefrom. Biological tissue samples are samples containing an aggregate of cells, usually of a particular kind, together with intracellular substances that form one of the structural materials of a human, animal, plant, bacterial, fungal or viral structure, including connective, epithelium, muscle and nerve tissues. Examples of biological tissue samples also include organs, tumors, lymph nodes, arteries and individual cell(s). for example, the sample can be a tissue sample suspected of being cancerous. Biological tissue samples may be first treated to separate aggregates of cells.

In embodiments, the biological sample comprises a blood cell, white blood cell or platelet. White blood cells (leukocytes) include neutrophils, lymphocytes (T cells inclusive of T helper cells, cytotoxic T cells, T-killer cells, Natural Killer, and B lymphocytes), monocytes, eosinophils, basophils, macrophages, and dendritic cells. The biological sample may include peripheral blood mononuclear cells (PBMC), such as T cells, monocytes, natural killer cells, and/or dendritic cells. The biological sample may include cells of various sizes.

As used herein, “biological population” is a subset of a biological sample, or a subsample thereof, as derived from a human or other organism, including a mammal. A biological population may include a collection, subset, or subpopulation of cells or other biological materials derived from urine, lymph, blood, plasma, serum, saliva, cervical fluid, cervical-vaginal fluid, vaginal fluid, breast fluid, breast milk, synovial fluid, semen, seminal fluid, stool, sputum, cerebral spinal fluid, tears, mucus, interstitial fluid, follicular fluid, amniotic fluid, aqueous humor, vitreous humor, peritoneal fluid, ascites, sweat, lymphatic fluid, lung sputum and/or lavage. A biological population which may be a “target biological population” can include cells, nucleic acids, proteins, peptides or other biologic structures. The biological population may include a collection or subsample of peripheral blood mononuclear cells (PBMC), such as T cells, monocytes, natural killer cells, and/or dendritic cells.

As used herein, “target cells” or “target cell suspension” are cells typically intended for desired separation or concentration from a cell suspension, which may include other cells or media (such as for examination or diagnosis), of particular type or having distinct characteristics relative to other cells. The cells not identified as “target cells” may be identified as “non-target cells” as used herein.

As used herein, “cell suspension” is a fluidic mixture or suspension of emulsion of cells or a combination thereof, and may be a fluid that includes any combination of buffer, biological sample (as previously described above), biological population, target cells, and/or sedimentation. In embodiments, the cell suspension may be provided from a proliferation chamber of an automated cell processing system or cell engineering system.

As used herein, “permeate” or “permeate flow” is a fluid separated from the cell suspension via a filtration material (e.g., a tangential flow filter as further described herein), and may contain a biological population, or target cells, that are separated from the remainder of the cell suspension. Alternatively, in embodiments, the “permeate” or “permeate flow” is leftover fluid and/or sedimentation that is separated from the cell suspension, and does not contain the biological population or target cells.

As used herein, “supernatant” is the leftover fluid and/or liquid that is separated from the target cells and/or sedimentation, and does not contain the biological population or target cells. Alternatively, in embodiments, the “supernatant” is the fluid separated from the cell suspension via a filtration material, by centripetal forces, or by other means of fluid separation described with respect to the various embodiments presented herein.

As used herein, “sediment” or “sedimentation” is the matter that settles to the bottom of a fluid and/or liquid, separated from the cell suspension. For example, a separated cell suspension may result in a supernatant with sediment or sedimentation settled in a layer underneath the supernatant. In embodiments, the sediment or sedimentation may include target cells and/or non-target cells.

As used herein “separation” includes isolation or collection accumulation of a target biological population including target cells from a surrounding fluid bulk or cell suspension, where the cell suspension is, as previously described above, a fluidic mixture or suspension of cells or a combination thereof, implying also concentration or enrichment of target cells relative to the surrounding feed flow or a provided sample of cells.

The present disclosure relates to embodiments of cell sedimentation modules and/or methods for integration into cell sedimentation systems as further described herein. The cell sedimentation module may comprise a housing, and a cell sedimentation vessel disposed within the housing. The cell sedimentation vessel may have sidewalls, a bottom surface, and a cell collection well formed in the bottom surface. A first flow line connected to the cell sedimentation module is configured for the input of a cell suspension, and the output of a supernatant. A second flow line connected to the cell sedimentation module is configured for the output of a target cell suspension. The cell sedimentation vessel and/or cell sedimentation module may be configured to non-mechanically generate a centripetal flow therein to facilitate the separation of the supernatant, the sediment, and/or the target cell suspension from the cell suspension. Alternatively, the cell sedimentation module may be configured to receive or contain multiple cell sedimentation vessels in a stacked configuration therein. In another alternative, the cell sedimentation vessel and/or cell sedimentation module may be configured to receive an insert configured to facilitate separation of the supernatant, the sediment, and/or the target cell suspension from the cell suspension, the insert further described in accordance with the embodiments presented herein.

In embodiments, the bottom surface of the cell sedimentation vessel may be substantially planar to facilitate generating the centripetal flow. In another embodiment, the bottom surface of the cell sedimentation vessel may be formed at an angle to facilitate generating the centripetal flow. In embodiments, the bottom surface of the cell sedimentation vessel may include a silicone lining. In further embodiments, the bottom surface of the cell sedimentation vessel may be formed to collect sediment and/or the target cell suspension separated from a fluid after flowing through the multi-level cell sedimentation vessel described herein, or through the inserts disposed within the cell sedimentation vessel as further described herein.

In embodiments, the second flow line may be disposed substantially along a vertical axis of the cell sedimentation vessel. The first flow line may be disposed off-center from the vertical axis of the cell sedimentation vessel. The first flow line may include a first flow line end disposed near the bottom surface of the cell sedimentation vessel, and the first flow line end may be angled with respect to the first flow line. In embodiments, the first flow line end may include a valve-controlled input section, and a valve controlled output section. The first flow line end may further include a fluid filter integrated with the first flow line end.

The systems, devices, and methods disclosed herein provide for efficient volume reduction, cell concentration, washing, and buffer exchange capabilities in connection with automated cell expansion and processing applications. The advantage of the systems, methods and devices disclosed herein lies in how the flow stream is allowed to be lower in force compared to other devices so that it can take advantage of the secondary flow effect (otherwise known as the “tea leaf effect” or the “tea leaf paradox”), where centripetal forces acting upon a fluid or emulsion cause matter contained within the fluid or emulsion to collect in the center and bottom of a container. This approach allows for the sedimentation to occur on a shorter distance that provides the option of rapid sedimentation cycles. Furthermore, the disclosed solution preserves product quality at a higher level compared to high flow-stream devices. The disclosed systems, methods and devices describe an alternative solution that provides a faster process and less shear force, both leading to higher product quality. It further provides the option of an integrable device that can be applied in-line in automated fluid processing systems, without the need of high energy and high cost machinery.

Alternatively, the advantage of the systems, methods, and devices disclosed herein lies in how separation efficiency and speed can be increased through the use of increased surface areas presented within the cell sedimentation module, e.g., through the use of stacked cell sedimentation vessels, and/or through the use of variously sized and shaped inserts configured to fit within the cell sedimentation vessels in accordance with the embodiments described herein.

The systems, devices, and methods disclosed herein specifically exclude a centrifuge, including a mechanical centrifuge, for generating any forces on biological samples and cells.

The embodiments of the cell sedimentation systems, methods, and modules further described herein are configured for incorporation with, and operation within, an automated cell processing system or cell engineering system. The automated cell processing system is configured for performing activating, transducing, expanding, concentrating, and/or harvesting steps, of cell cultures. Automated cell engineering systems (also called automated biologic processing units throughout) provide for the automated production of cell cultures. As used herein “cell cultures” refers to any suitable cell type, including individual cells, as well as multiple cells or cells that may form into tissue structures. Exemplary cell cultures include blood cells, skin cells, muscle cells, bone cells, cells from various tissues and organs, etc., In embodiments, genetically modified immune cells, including CAR T cells, as described herein, can be produced. Exemplary automated cell engineering systems are also called COCOON®, or COCOON® system throughout (see e.g., U.S. Published Patent Application No. 2019/0169572, the disclosure of which is incorporated by reference herein in its entirety). In particular, the embodiments of the cell sedimentation modules described herein are for attachment as an accessory to a cell expansion cassette of the automated cell processing system or cell engineering system, in which fluid is flowed into the cell sedimentation modules at the end of a cell expansion process that occurs within the cell expansion cassette.

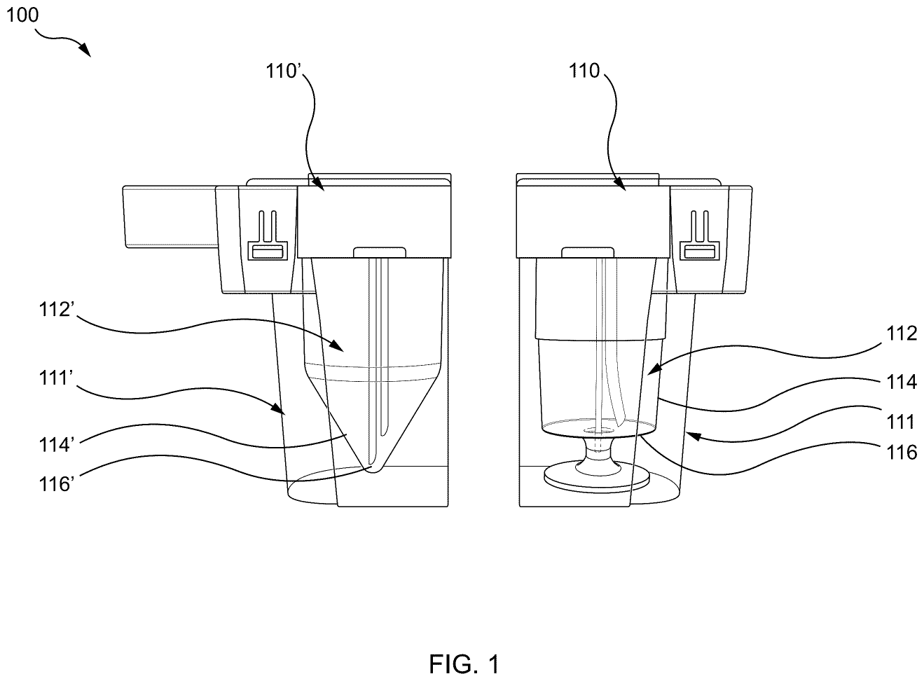

Exemplary embodiments of cell sedimentation modules 110, 110′ of a cell sedimentation system 100 are illustrated in FIG. 1. In particular, an embodiment of the cell sedimentation module 110′ comprises a housing 111′ with a cell sedimentation vessel 112′ disposed therein. The cell sedimentation vessel 112′ of cell sedimentation module 110′ is formed in a conical shape, such that the sidewalls of the cell sedimentation vessel 112′ taper inwards toward the bottom surface 116′. An alternative embodiment of the cell sedimentation module 110 comprises a similarly configured housing 111 with a cell sedimentation vessel 112 disposed therein, where this cell sedimentation vessel 112 is formed in a cylindrical shape. In other words, the sidewalls 114 are substantially vertical, and connect to a bottom surface 116 having a substantially planar configuration. The housing 111′, 111 (and other housings further described herein) are configured for attachment, connection, or incorporation with the automated cell processing systems or cell engineering systems as previously described above.

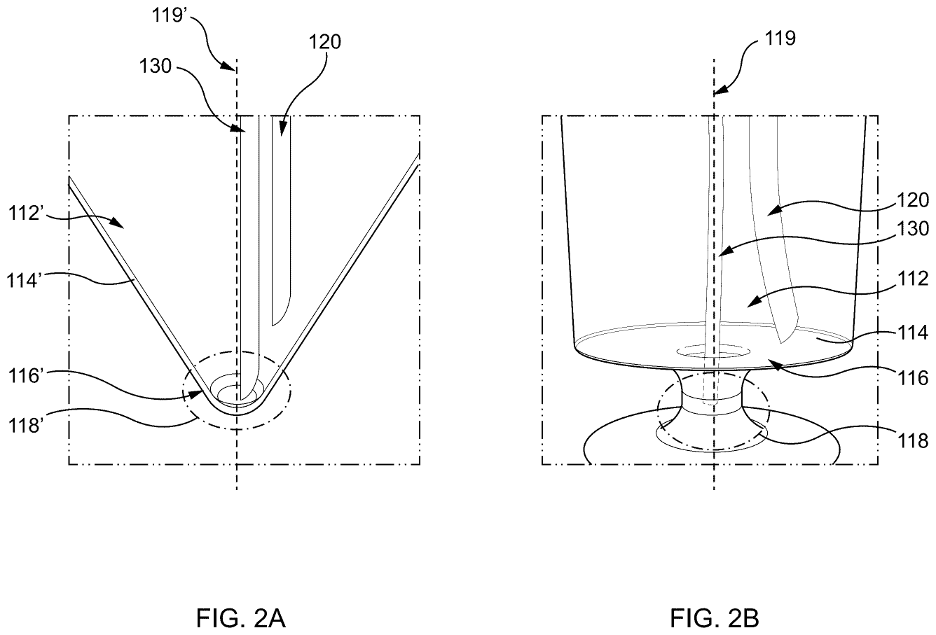

FIGS. 2A and 2B illustrate the structure of the cell sedimentation vessels 112, 112′ that are received within the housing 111, 111′ of the cell sedimentation modules 110, 110′. In the embodiment of the cell sedimentation vessel 112′ shown in FIG. 2A, the cell sedimentation vessel 112′ is formed with sidewalls 114′ connected to a bottom surface 116′, with a cell collection well 118′ formed into the bottom surface 116′, configured for the collection of a sediment or target cell suspension as further described herein. The bottom surface 116′ of the cell sedimentation vessel 112′ is formed at an angle. In other words, the sidewalls 114′ angle or taper inward starting from the top of the cell sedimentation vessel 112′ toward the bottom surface 116′ to form the angled bottom surface 116′, such that the cell collection well 118′ is formed in the bottom surface 116′ where the tapering sidewalls 114′ connect. A first flow line 120 may be disposed within the cell sedimentation vessel 112′, configured for the input of a cell suspension and output of a supernatant. A second flow line 130 may also be disposed within the sedimentation vessel 112′, configured for output of sediment or a target cell suspension that collects within the cell collection well 118′. In embodiments, the first flow line 120 may be disposed off-center from a vertical axis 119′ of the cell sedimentation vessel 112′, and the second flow line 130 may be disposed substantially along a vertical axis 119′ of the cell sedimentation vessel 112′.

Alternatively, the embodiment of the cell sedimentation vessel 112 shown in FIG. 2B is constructed in a cylindrical manner, such that the sidewalls 114 are substantially vertical from the top of the cell sedimentation vessel 112 toward the bottom surface 116 of the cell sedimentation vessel 112. The bottom surface 116 of the cell sedimentation vessel 112 is substantially planar in this configuration. The cell collection well 118 is formed substantially in the axial center of the planar surface of the bottom surface 116, extending past the bottom surface 116 or underside of the bottom surface 116. A first flow line 120 may be disposed within the cell sedimentation vessel 112, configured for the input of a cell suspension and output of a supernatant. A second flow line 130 may also be disposed within the sedimentation vessel 112, configured for output of sediment or a target cell suspension that collects within the cell collection well 118. In embodiments, the first flow line 120 may be disposed off-center from a vertical axis 119 of the cell sedimentation vessel 112, and the second flow line 130 may be disposed substantially along a vertical axis 119 of the cell sedimentation vessel 112.

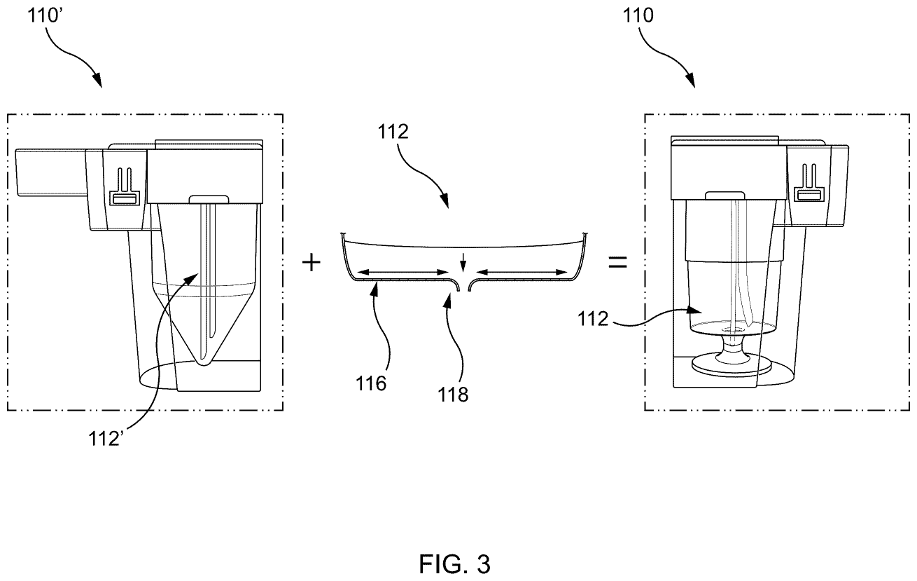

FIG. 3 illustrates how cell sedimentation module 110 is designed. By removing the conical portion of the cell sedimentation vessel 112′ of cell sedimentation module 110′, and replacing it with the cylindrically structured cell sedimentation vessel 112 and corresponding cell collection well 118 disposed underneath the bottom surface 116, the cell sedimentation module 110 may be formed.

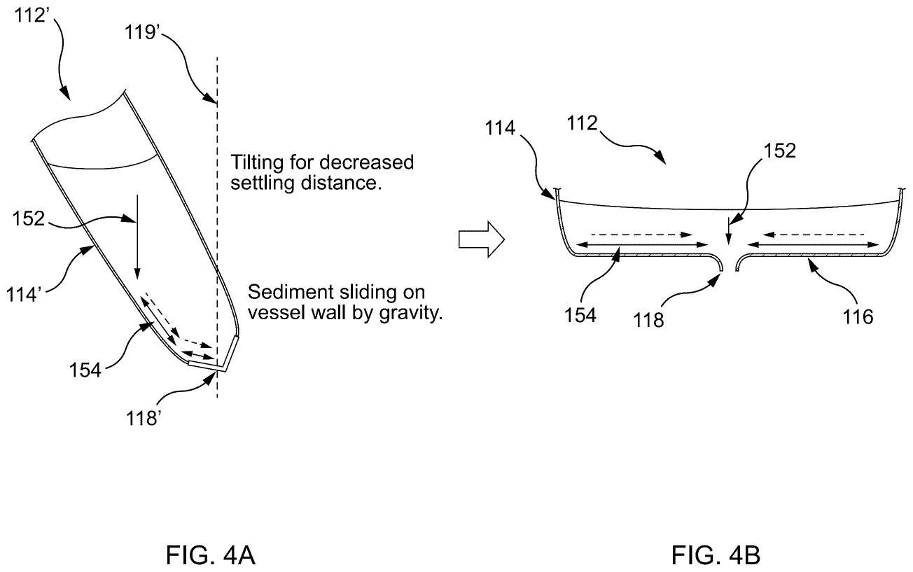

FIGS. 4A and 4B illustrate how an optimized collection method of the cell sedimentation vessel 112′ (shown in FIG. 4A) also influenced the creation of the cylindrical cell sedimentation vessel 112 (shown in FIG. 4B). With reference to FIG. 4A, it was found that, as primary flow (e.g., fluid introduced by the first flow line 120) is introduced into the sedimentation vessel 112′, by tilting the cell sedimentation vessel 112′ off its vertical axis 119′, the settling distance of sedimentation 152 (generated by secondary flow 154 via the secondary flow effect or the tea leaf paradox as described above) was decreased, as the sedimentation 152 would first contact the vessel sidewalls 114′ then travel downslope via gravitational forces toward the cell collection well 118′, generating the secondary flow 154. Tilting the sedimentation vessel 112′ would further result in reduced gravitational forces acting on the sedimentation 152. With this understanding, the cylindrical sedimentation vessel 112 was designed to have less height (i.e., shorter sidewalls 114), so as to achieve reduced gravitational forces acting upon the sedimentation 152 as it collects within the sedimentation vessel 112. The secondary flow 154 would then spread across the bottom surface 116 (generated by the secondary flow effect or the tea leaf paradox).

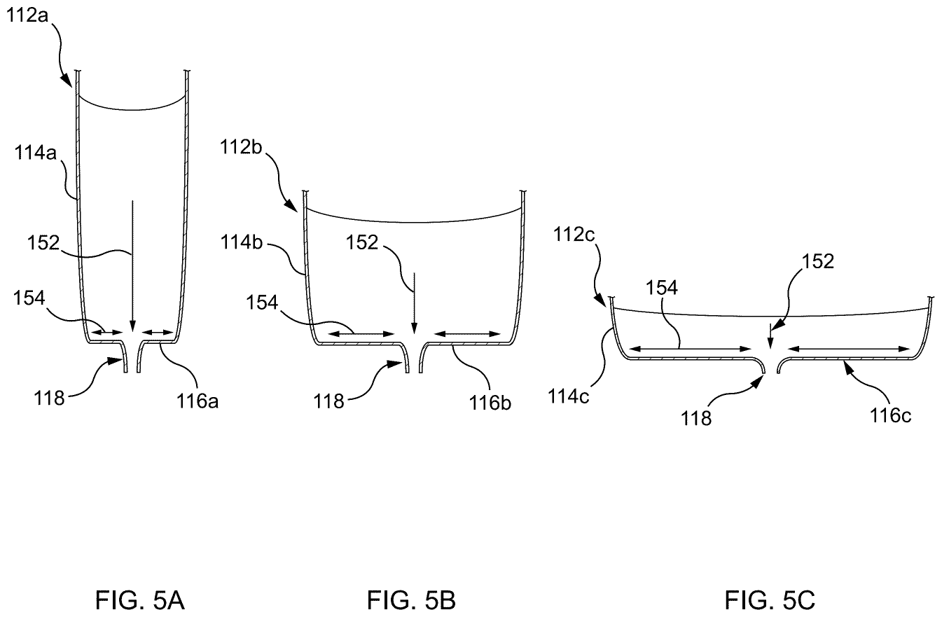

FIGS. 5A-5B illustrate embodiments of the cylindrical sedimentation vessel 112a, 112b, 112c, each having different dimensions, particularly with respect to the lengths of the bottom surfaces 116a, 116b, 116c, and to the heights of the sidewalls 114a, 114b, 114c. In FIG. 5A, the sedimentation vessel 112a has the largest ratio of sidewall 114a height to bottom surface 116a length. In other words, the sidewall 114a height is the largest across the three presented sedimentation vessel embodiments 112a, 112b, 112c, and the bottom surface 116a length is the smallest across the three presented sedimentation vessel embodiments 112a, 112b, 112c. Having this configuration, the gravitational forces acting upon the sedimentation 152 are the largest among the three sedimentation vessel embodiments 112a, 112b, 112c, and the secondary flow 154 has the shortest path of travel along the bottom surface 116a. In FIG. 5B, the sedimentation vessel 112b has the most proportional ratio of sidewall 114b height to bottom surface 116b length. In other words, the sidewall 114b height is approximate in measurement to the bottom surface 116b length. Having this configuration, the gravitational forces acting upon the sedimentation 152 of sedimentation vessel 112b are lesser than that of sedimentation vessel 112a, but greater than that of sedimentation vessel 112c. The secondary flow 154 of sedimentation vessel 112b also has a longer path of travel along the bottom surface 116b when compared to sedimentation vessel 112a, but has a shorter path of travel along the bottom surface 116b when compared to sedimentation vessel 112c. In FIG. 5C, the sedimentation vessel 112c has the smallest ratio of sidewall 114c height to bottom surface 116c length. In other words, the sidewall 114c height is the smallest across the three presented sedimentation vessel embodiments 112a, 112b, 112c, and the bottom surface 116c length is the largest across the three presented sedimentation vessel embodiments 112a, 112b, 112c. Having this configuration, the gravitational forces acting upon the sedimentation 152 are the smallest among the three sedimentation vessel embodiments 112a, 112b, 112c, and the secondary flow has the longest path of travel along the bottom surface 116c.

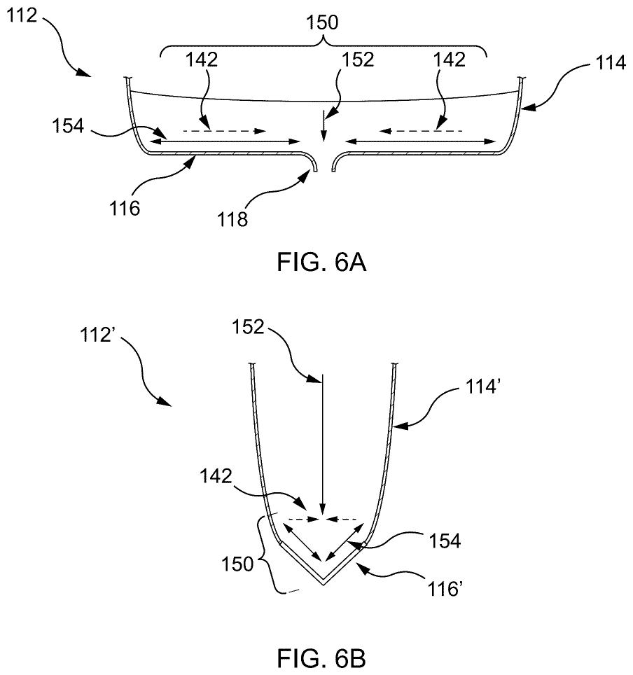

FIGS. 6A and 6B illustrate how a centripetal flow 150 may be generated in both the cylindrical sedimentation vessel 112 and conical sedimentation vessel 112′ embodiments as previously described herein. As illustrated in FIG. 6A, when primary flow (e.g., fluid introduced via the first flow line 120) is introduced into the sedimentation vessel 112, it generates a centripetal force which disperses along the bottom surface 116 as secondary flow 154 (i.e., rotating toward the sidewalls 114). As the secondary flow 154 is formed, it folds or roils over and travels in a direction upwards towards the center of the sedimentation vessel 112 (i.e., along the vertical axis of the cell collection well 118), then outwards towards the sidewalls 114. While this is occurring, the primary flow (i.e., cell suspension introduced into the sedimentation vessel 112) is separated via the secondary flow 154 into a top layer of supernatant 142, and a bottom layer of sediment. The secondary flow effect then results in sedimentation 152 being pulled downward along the vertical axis towards the cell collection well 118. As illustrated in FIG. 6B, when primary flow (e.g., fluid introduced via the first flow line 120) is introduced into the conical sedimentation vessel 112′, it generates a centripetal force which disperses along the bottom surface 116′ as secondary flow 154 (i.e., rotating toward the sidewalls 114′). As the secondary flow 154 is formed, it folds or roils over and travels in a direction upwards towards the center of the sedimentation vessel 112′ (i.e., along the vertical axis of the cell collection well 118′), then outwards towards the sidewalls 114′. While this is occurring, the primary flow (i.e., cell suspension introduced into the sedimentation vessel 112′) is separated via the secondary flow 154 into a top layer of supernatant 142, and a bottom layer of sediment. The secondary flow effect then results in sedimentation 152 being pulled downward along the vertical axis towards the cell collection well 118′.

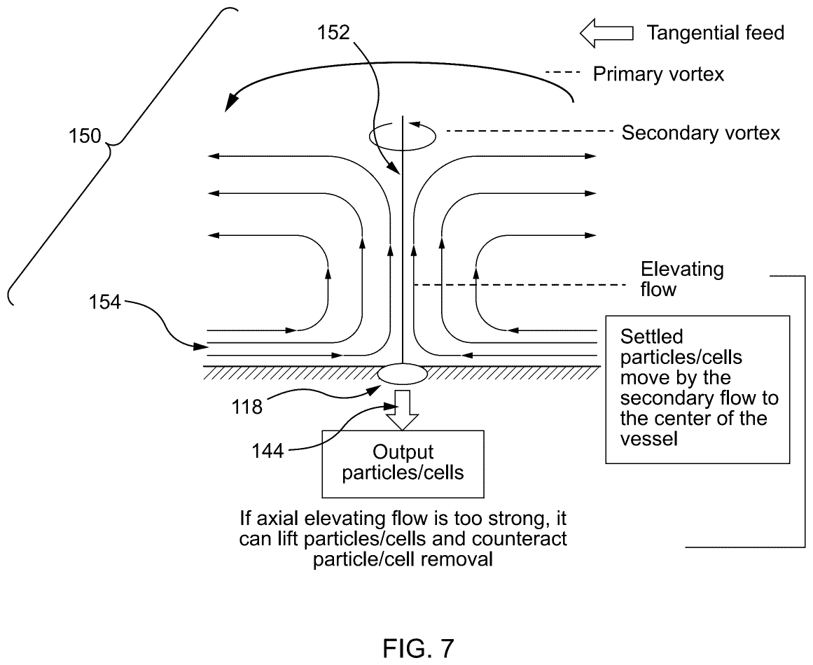

FIG. 7 further diagrams how centripetal flow 150 may be generated in the sedimentation vessel embodiments 112, 112a, 112b, 112c, 112′ previously described herein (and in the further sedimentation vessel embodiments 212, 300 later described below), and how such centripetal flow is used to generate separation of sedimentation, target cell suspension, and supernatant from an input cell suspension or primary flow. Generally, the bottom surface 116 of the sedimentation vessel 112, 112a, 112b, 112c, 112′ in combination with the forces generated from an incoming primary flow or cell suspension enables the occurrence of the secondary flow effect, which has the potential to guide the sedimented cells towards the cell collection wells 118, 118′ of the sedimentation vessel embodiments 112, 112a, 112b, 112c, 112′ previously described herein. As shown in FIG. 7, the primary flow or cell suspension introduced into the sedimentation vessel 112, 112a, 112b, 112c, 112′ creates a primary vortex that generates a centripetal force pulling towards the center of the sedimentation vessel. In other words, pressure on the outside of the primary vortex decreases, while pressure on the inside of the vortex increases. The decrease in pressure on the outside of the primary vortex is a result of frictional forces acting upon the swirling fluid, the frictional forces being generated by the fluid contacting the sidewalls and bottom surface of the sedimentation vessel 112, 112a, 112b, 112c, 112′ as it swirls or roils. As this centripetal flow 150 continues, settled particles/cells (aka sedimentation and or target cell suspension) are moved by the secondary flow 154 toward the axial center of the sedimentation vessel, where the cell collection well 118 would be located in the embodiments of the sedimentation vessel 112, 112a, 112b, 112c, 112′ previously described herein. Sedimentation would then collect in the middle of the sedimentation vessel 112, 112a, 112b, 112c, 112′ as a result in these pressure differentials, (the pressure differentials which further create a secondary vortex in the center of the centripetally flowing fluid), and the sedimentation, which may include a target cell suspension 144 would then be forced downward into the collection well 118.

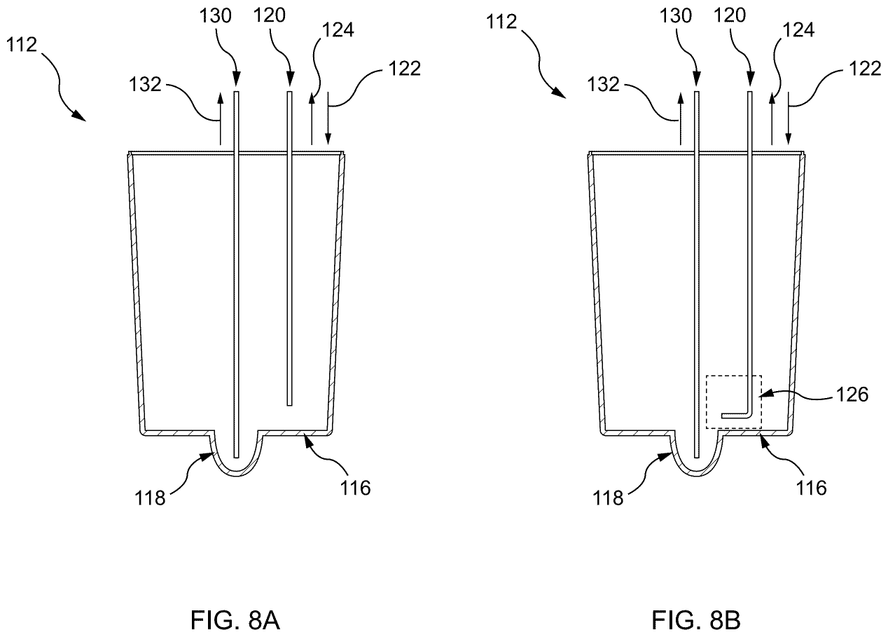

FIGS. 8A and 8B illustrate embodiments of the input and output flow lines that may be integrated into the sedimentation vessel embodiments 112, 112a, 112b, 112c, 112′ previously described herein (and in the further sedimentation vessel embodiments 212, 300 later described below). As seen in FIG. 8A, the sedimentation vessel 112 includes the first flow line 120 and the second flow line 130 as previously described. The first flow line 120 may be configured for an input flow 122 flowing into the sedimentation vessel 112, which may be a primary flow or cell suspension, and an output flow 124, which may be a supernatant, leaving the sedimentation vessel 112. The second flow line 130 may be configured for an output flow 132, which in embodiments may be a supernatant, or in alternative embodiments may be the sedimentation or the target cells as defined herein. As shown in FIG. 8B, the first flow line 120 may further include a first flow line end 126 that is bent or angled between approximately 10-90 degrees (with respect to the longitudinal axis of the first flow line 120). This bend or angle of the first flow line end 126 changes the angle of the force of primary flow entering into the sedimentation vessel 112, which facilitates improved circular flow generation within the sedimentation vessel 112, and thus the generation of centripetal flow as previously described herein. The first flow line 120 may be configured for an input flow 122 flowing into the sedimentation vessel 112, which may be a primary flow or cell suspension, and an output flow 124, which may be a supernatant, leaving the sedimentation vessel 112. The second flow line 130 may be configured for an output flow 132, which in embodiments may be a supernatant, or in alternative embodiments may be the sedimentation or the target cells as defined herein.

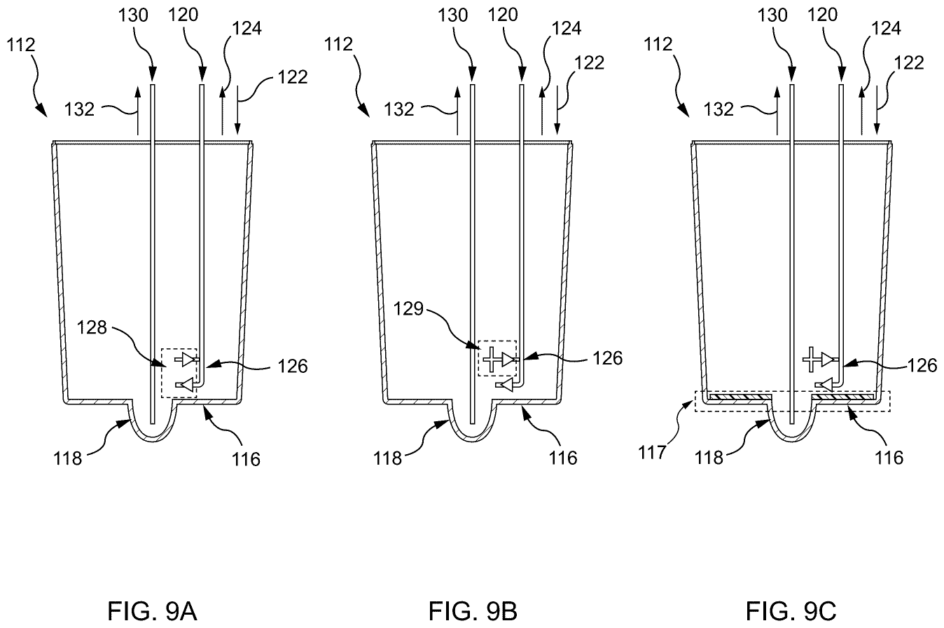

FIGS. 9A-9C illustrate further embodiments of the input and output flow lines that may be integrated into the sedimentation vessel embodiments 112, 112a, 112b, 112c, 112′ previously described herein (and in the further sedimentation vessel embodiments 212, 300 later described below). As shown in FIG. 9A, the first flow line 120 may further include a valve input section 128 at or near the first flow line end 126. More particularly, the valve input section 128 may be configured to allow for individual valve-controlled input flow 122 and output flow 124 through separate sections or locations on the first flow line 120, or more particularly on the first flow line end 126. The first flow line end 126 may be bent or angled between approximately 10-90 degrees (with respect to the longitudinal axis of the first flow line 120). The first flow line 120 may be configured for an input flow 122 flowing into the sedimentation vessel 112, which may be a primary flow or cell suspension, and an output flow 124, which may be a supernatant, leaving the sedimentation vessel 112. The second flow line 130 may be configured for an output flow 132, which in embodiments may be a supernatant, or in alternative embodiments may be the sedimentation or the target cells as defined herein.

As shown in FIG. 9B, the first flow line 120 may further include a flow line end fluid filter 129 at or near the first flow line end 126. In embodiments, the flow line end fluid filter 129 may be integrated in a supernatant removal tube section of the first flow line 120. The first flow line end 126 may be bent or angled between approximately 10-90 degrees (with respect to the longitudinal axis of the first flow line 120). The first flow line 120 may be configured for an input flow 122 flowing into the sedimentation vessel 112, which may be a primary flow or cell suspension, and an output flow 124, which may be a supernatant, leaving the sedimentation vessel 112. The second flow line 130 may be configured for an output flow 132, which in embodiments may be a supernatant, or in alternative embodiments may be the sedimentation or the target cells as defined herein.

As shown in FIG. 9C, the bottom surface 116 of the sedimentation vessel 112, 112a, 112b, 112c, may further include a silicone lining 117 disposed on or adjacent to the bottom surface 116 for improved cell transfer on the sedimentation surface, in addition to the various embodiments of the first flow line 120 previously described with respect to FIGS. 8A-9B above. As may be understood by one having ordinary skill in the art, the above-described sedimentation vessel 112, 112a, 112b, 112c may include some, all, or any combination of the valve input section 128, the flow line end fluid filter 129, and/or the silicone lining 117, and the embodiments should not be construed as being limited to those illustrated in FIGS. 9A-9C. Furthermore, the silicone lining 117 may further be integrated into the sedimentation vessel embodiments 112, 112a, 112b, 112c, 112′ previously described herein, and in the further sedimentation vessel embodiments 212, 300 later described below.

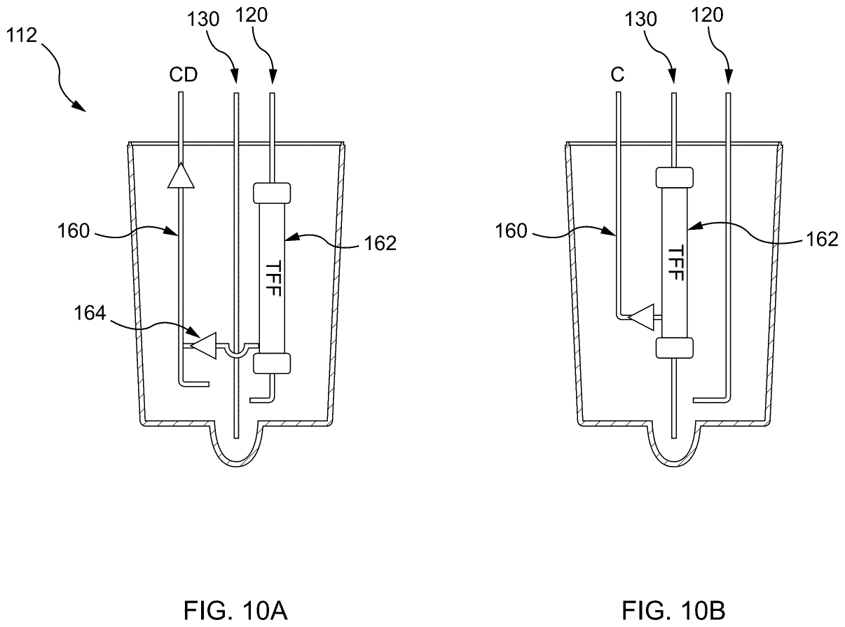

FIGS. 10A and 10B illustrate further embodiments of the first flow lines 120 and second flow lines 130 that may be integrated into the sedimentation vessel embodiments 112, 112a, 112b, 112c, 112′ previously described herein (and in the further sedimentation vessel embodiments 212, 300 later described below). In particular, the sedimentation vessel 112 may further integrate a tangential flow filtration (TFF) unit 162 integrated with the first flow line 120, as illustrated in FIG. 10A. As input flow enters and flows through the first flow line 120, permeate flow may be formed within the TFF unit 162 and exit as a TFF permeate output 164, the TFF permeate output 164 which may further flow into a TFF permeate output line 160 that flows the TFF permeate output 164 out of the sedimentation vessel 112. In an alternative embodiment as illustrated FIG. 10B, the TFF unit 162 may be integrated with the second flow line 130. As output flow travels through the second flow line 130, permeate flow may be formed within the TFF unit 162 and exit as a TFF permeate output 164, the TFF permeate output 164 which may further flow into a TFF permeate output line 160 that passes the TFF permeate output 164 out of the sedimentation vessel 112, 112a, 112b, 112c. In general, the integration of the TFF unit 162 with the first flow line 120 and/or second flow line 130 can further enhance the enrichment process. That is, the TFF unit 162 may further facilitate the separation of the sedimentation and/or the target cell suspension from the cell suspension and/or supernatant.

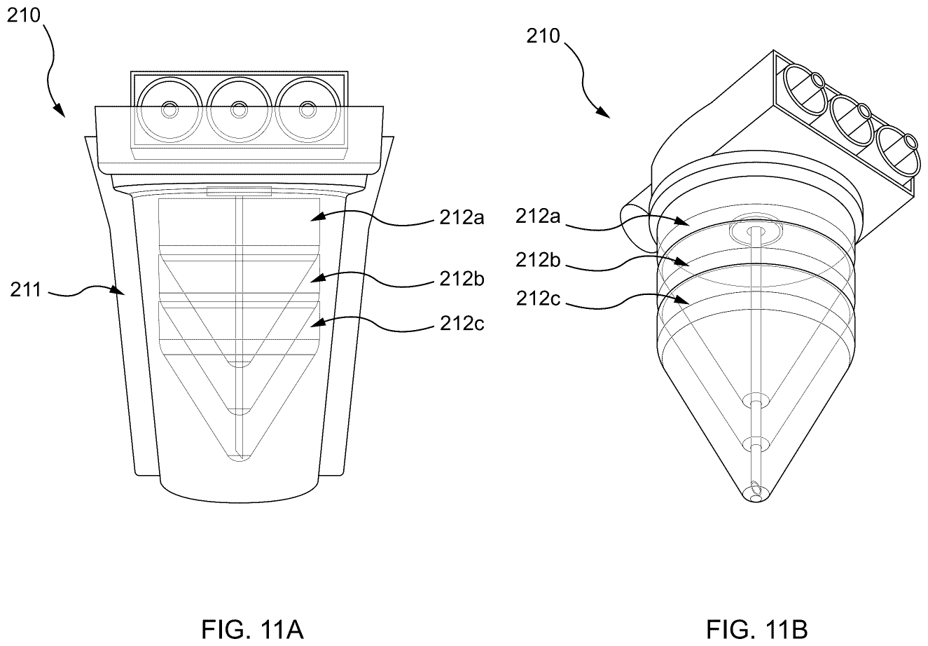

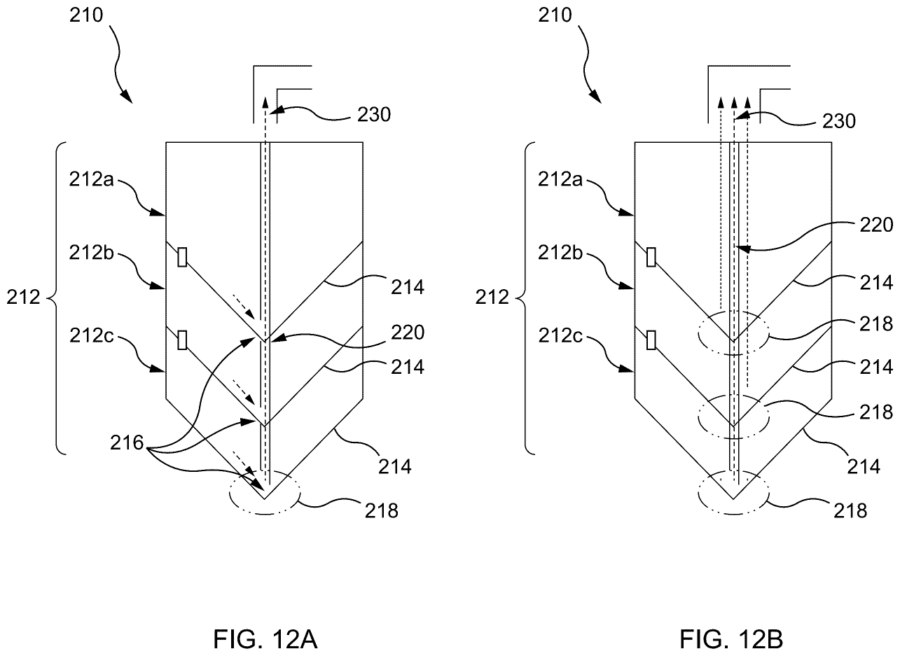

FIGS. 11A and 11B illustrate embodiments of a multi-level sedimentation module 210, which comprises a multi-level cell sedimentation vessel 212 having a plurality of sedimentation vessels 212a, 212b, 212c sequentially oriented relative to each other and disposed within a housing 211 (as shown in FIG. 11A) configured for attachment, connection, or incorporation with the automated cell processing systems or cell engineering systems as previously described above. More particularly, the sedimentation vessels 212a, 212b, 212c are formed in a conical manner, having sidewalls 214 tapering into a bottom surface 216 with a cell collection well 218 formed into the bottom surface 216 of at least one of the plurality of vessels 212a, 212b, 212c. FIGS. 12A and 12B further diagram these components of the multi-level sedimentation module 210, including the structure of the sedimentation vessels 212a, 212b, 212c. In embodiments, at least one input flow line 220 is configured for input of a primary flow or a cell suspension into at least one of the plurality of vessels 212a, 212b, 212c, and output of a supernatant from at least one of the plurality of vessels 212a, 212b, 212c. At least one output flow line 230 may further be configured for output of a sedimentation or a target cell suspension from the cell collection well formed into the bottom surface 216 of the at least one of the plurality of vessels 212a, 212b, 212c. In the embodiment illustrated in FIG. 12A, the cell sedimentation module 210 has the cell collection well 218 formed into the bottom surface 216 of the final, sequential vessel 212c. In the embodiment illustrated in FIG. 12B, the cell sedimentation module 210 has a plurality of cell collection wells 218 formed into the bottom surface of each of the plurality of vessels 212a, 212b, 212c.

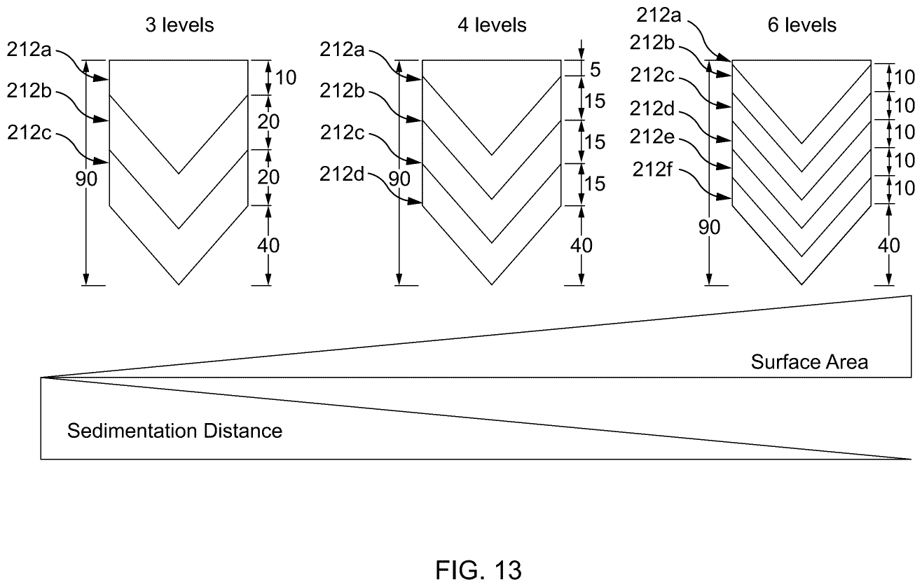

It should be understood by those having skill in the art that the cell sedimentation module 210 may comprise a plurality of sedimentation vessels, and is not limited to only the three sedimentation vessels 212a, 212b, 212c illustrated in FIGS. 11A-12B. For example, as illustrated in FIG. 13, the cell sedimentation module 210 may comprise three sedimentation vessels, 212a, 212b, 212c, four sedimentation vessels 212a-212d, or six sedimentation vessels 212a-212f. In further embodiments, the cell sedimentation module 210 may comprise anywhere between one to seven sedimentation vessels (not shown), or any number of sedimentation vessels that can fit within the sedimentation vessel housing 211 in a sequential orientation. As further illustrated in FIG. 13, the lower the number of sedimentation vessels being used in the cell sedimentation module 210, the higher the sedimentation distance. Conversely, the lower the number of sedimentation vessels being used in the sedimentation module 210, the lower the available surface area. Furthermore, it should be understood by those having ordinary skill in the art that the various embodiments of the multi-level sedimentation module 210 described above with respect to FIGS. 11A-13 may be configured in a manner similar to the previously-described cell sedimentation vessels 112′, 112, 112a, 112b, 112c, such that the input flow lines 220 may be configured for input of a primary flow or a cell suspension, and for generating a centripetal flow within each sequential sedimentation vessel 212a-212f, so as to produce a secondary flow that separates sedimentation and/or target cell suspension from supernatant, the input flow lines 220 which may further be configured for output of the supernatant, and that the output flow lines 230 integrated into the multi-level sedimentation module 210 may be configured for output of the sedimentation and/or target cell suspension.

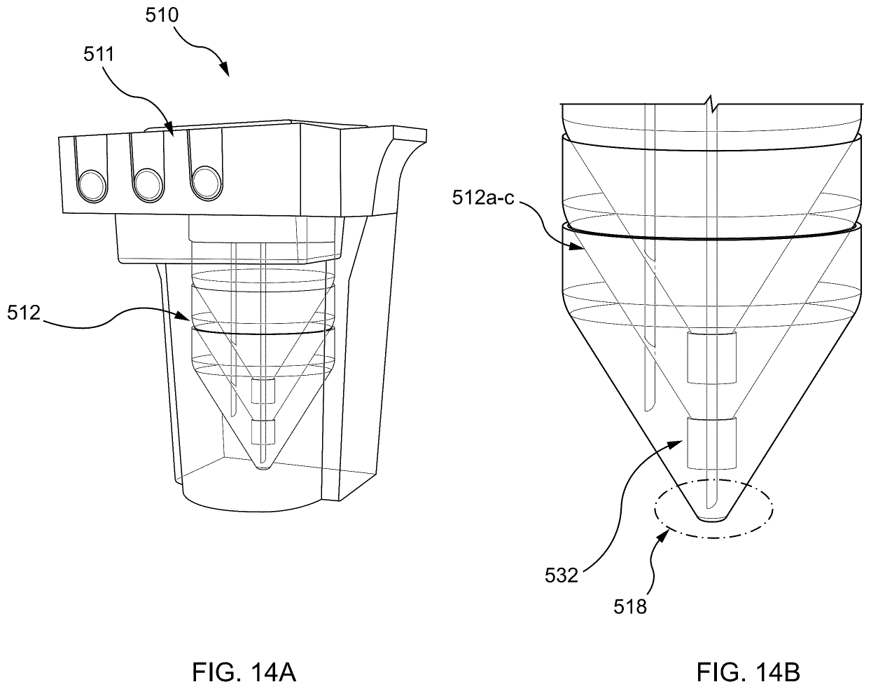

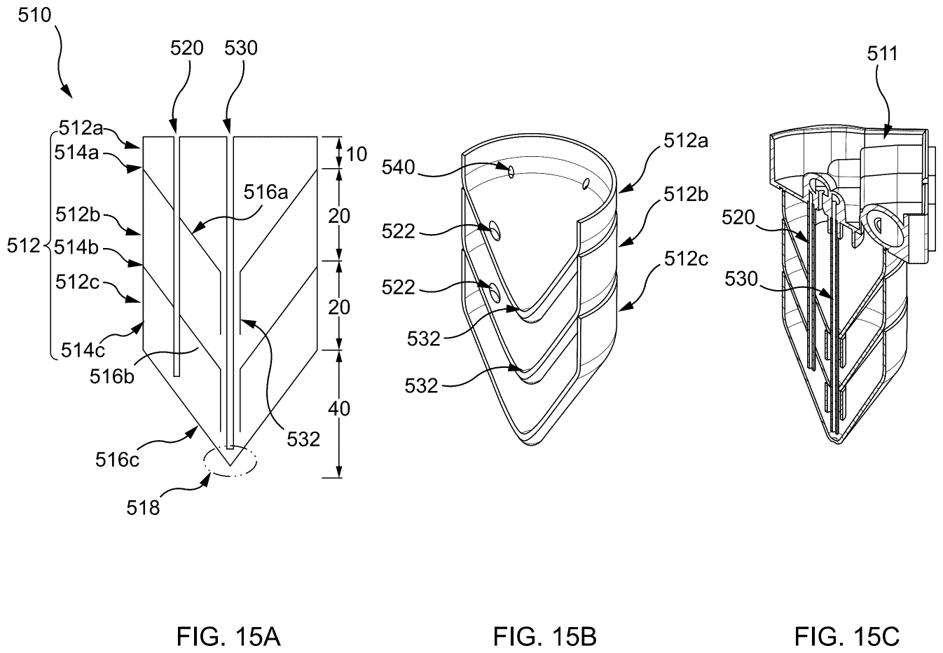

FIGS. 14A-17 illustrate another embodiment of a multi-level cell sedimentation module 510 which comprises a multi-level cell sedimentation vessel 512 having a plurality of sedimentation vessels 512a, 512b, 512c sequentially oriented relative to each other and disposed within a housing 511 (as shown in FIGS. 14A and 14B) configured for attachment, connection, or incorporation with the automated cell processing systems or cell engineering systems as previously described above. More particularly, the sedimentation vessels 512a, 512b, 512c are formed in a conical manner, having sidewalls 514a, 514b, 514c tapering into a bottom surface 516a, 516b, 516c with a cell collection well 518 formed into the bottom surface 516c of the bottommost vessel 512c. FIGS. 15A-15C further diagram these components of the multi-level sedimentation module 510, including the structure of the sedimentation vessels 512a, 512b, 512c, in a cross-sectional display. In embodiments, at least one sedimentation flow line 530 is disposed substantially along a vertical axis of the sedimentation vessels 512a, 512b, 512c, running through a sedimentation channel 532 formed through the bottom surfaces 516a, 516b of sedimentation vessels 512a, 512b and ending at or near the collection well 518 formed in sedimentation vessel 512c. The sedimentation flow line 530 is a tube, straw, or other fluidic pathway configured for the ingress/egress or flow of sedimentation formed within the cell sedimentation module 510. For example, the sedimentation flow line 530 may be configured to output or extract sedimentation collected and settled in the collection well 518 at the bottom of sedimentation vessel 512c. Sedimentation extracted from the collection well 518 may then be fed or flowed into the automated cell processing system or cell engineering system for further processing. In embodiments, at least one supernatant flow line 520 is disposed adjacent to the sidewalls 514a, 514b, 514c of sedimentation vessels 512a, 512b, 512c, running through a supernatant channel 522 formed through the sidewalls 514a, 514b of the sedimentation vessels 512a, 512b, and ending at or near the sidewall 514c of the sedimentation vessel 512c. The supernatant flow line 520 is a tube, straw, or other fluidic pathway configured for the ingress/egress or flow of supernatant collected within the cell sedimentation module 510. For example, the supernatant flow line 520 may be configured for the input of a primary flow, a cell suspension, and/or supernatant into the cell sedimentation module 510. The supernatant flow line 520 may also be configured for the output or extraction of supernatant collecting within the cell sedimentation vessels 512a, 512b, 512c. In embodiments, supernatant extracted from the cell sedimentation vessels 512a, 512b, 512c may then be fed or flowed into the automated cell processing system or cell engineering system for further processing, or alternatively, to a waste container. The cell sedimentation module 510 may further include an air outlet 540 to allow for gas or air building up within the cell sedimentation module 510 to pass into a surrounding ambient environment, or alternatively into the automated cell processing system or cell engineering system for further processing.

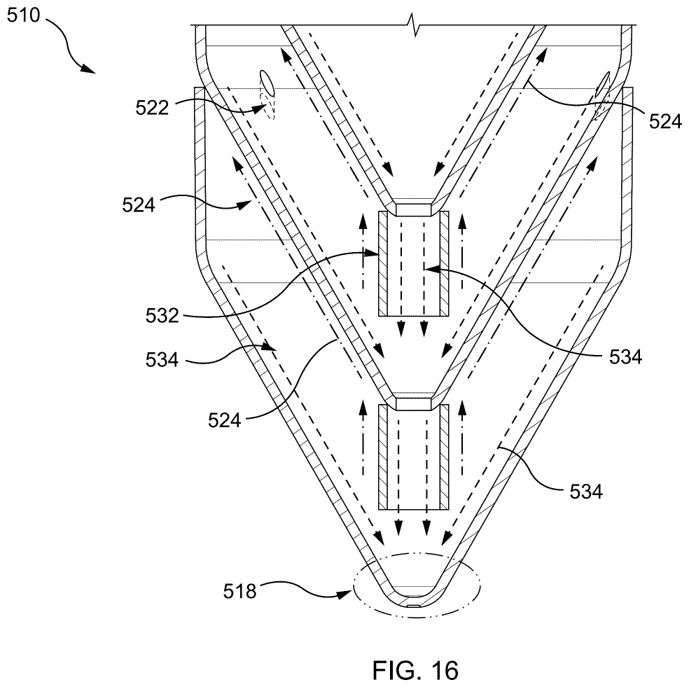

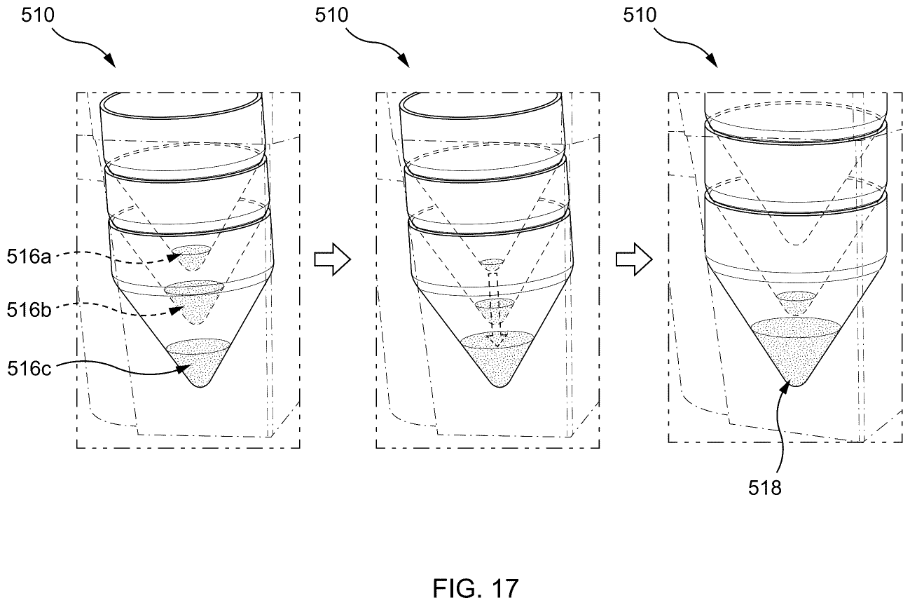

FIG. 16 illustrates the flow of fluids within the cell sedimentation vessel 510. In particular, the flow of supernatant flow 524 and sediment flow 534 is diagramed in a cross-sectional view of the cell sedimentation vessel 510. In embodiments, supernatant flow 524 is shown traveling upwards within the sedimentation vessels 512a, 512b, 512c while sedimentation flow 534 travels downwards within the sedimentation vessels 512a, 512b, 512c and through the sedimentation channel 532. FIG. 16 further illustrates how a centripetal flow may be generated in the sedimentation vessels 512a, 512b, 512c as previously described herein. When primary flow (e.g., fluid introduced via the sediment flow line 530 or by other fluid introduction ports) is introduced into the sedimentation vessel 510, it generates a centripetal force which disperses along the bottom surfaces 516a, 516b, 516c as secondary flow (i.e., rotating toward the sidewalls 514a, 514b, 514c). As the secondary flow is formed, it folds or roils over and travels in a direction upwards adjacent to the center of the sedimentation vessels 512a, 512b, 512c (i.e., along the vertical axis of the cell collection well 518 or sedimentation channel 532), then outwards towards the sidewalls 514a, 514b, 514c. While this is occurring, the primary flow (i.e., cell suspension introduced into the sedimentation vessels 512a, 512b, 512c) is separated via the secondary flow into a top layer of supernatant flow 524, and a bottom layer of sediment flow 534. The secondary flow effect then results in sedimentation being pulled downward along the vertical axis towards the cell collection well 518, through the stacked layers of the sedimentation vessels 512a, 512b, 512c. Sediment formed in the cell sedimentation vessels 512a, 512b channel toward the cell collection well 518 through the sediment channel 532. This separation therefore allows extraction of the sediment flow 534 via the sediment flow line 530, and extraction of the supernatant flow 524 via the supernatant flow line 520. FIG. 17 illustrates this process, showing how supernatant and sediment separates over time, with sediment collecting on the bottom surfaces 516a, 516b, 516c of each sedimentation vessel 512a, 512b, 512c, and over time, as supernatant is removed, the sediment distributed across the bottom surfaces 516a, 516b, 516c of each sedimentation vessel 512a, 512b, 512c eventually settles and collects within the collection well 518 (as demonstrated by the dashed downward arrow shown in the middle figure).

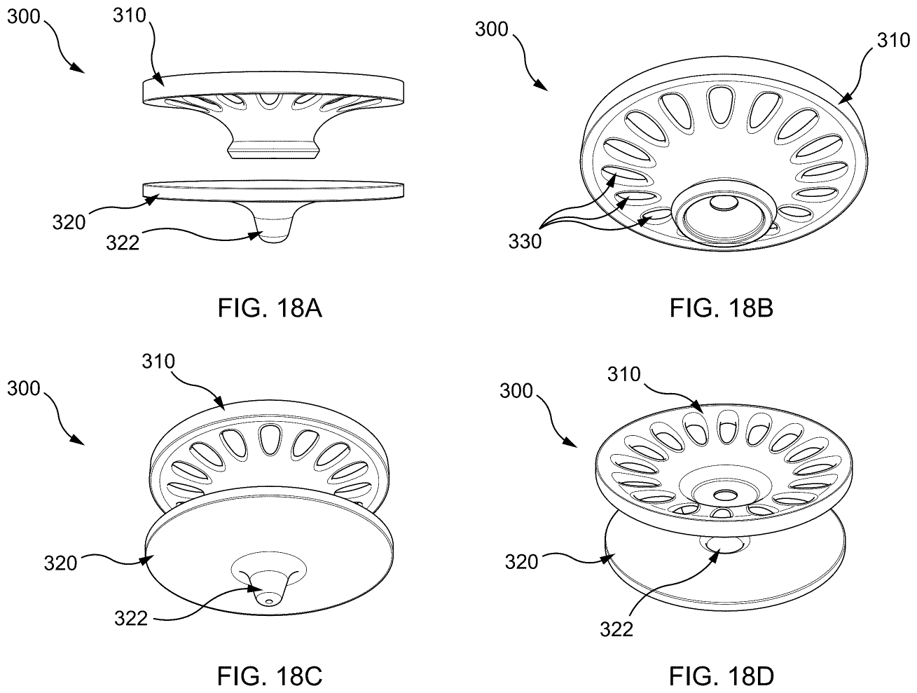

FIGS. 18A-18D illustrate another embodiment of a cell sedimentation module. The cell sedimentation module may comprise a housing as previously described herein. The housing may further be configured for receiving a cell sedimentation vessel 300 disposed within the housing. The cell sedimentation vessel 300 may have sidewalls (not shown), a bottom surface 320, and a cell collection well 322 formed into the bottom surface 320. The cell sedimentation vessel 300 may comprise a press filter 310 disposed within the cell sedimentation vessel housing, and above the bottom surface 320. The press filter 310 may have a substantially conical shape with a plurality of openings 330 disposed thereon to allow for flow of a cell suspension therethrough. A first flow line (not shown) as previously described herein may be configured for input of the primary flow or the cell suspension, and for output of a supernatant, and a secondary flow line (not shown) as previously described herein may be configured for output of a sedimentation, or a target cell suspension. The cell sedimentation vessel 300 and the corresponding press filter 310 are configured to non-mechanically generate a centripetal flow therein to facilitate separation of the supernatant and the sedimentation or the target cell suspension from the cell suspension.

In embodiments, the press filter 310 and the bottom surface 320 may instead be separate components configured for integration into the previously described sedimentation vessel embodiments 112′, 112, 112a, 112b, 112c, 212. In other words, the press filter 310 and the bottom surface 320 may be dimensioned to fit snugly within the previously described sedimentation vessel embodiments 112′, 112, 112a, 112b, 112c, 212. Integration of the press filter 310 and the bottom surface 320 into these previously described sedimentation vessel embodiments may even further facilitate the generation of centripetal forces (and thus the separation of supernatant from sedimentation and/or target cell suspension) within the previously described sedimentation vessel embodiments 112′, 112, 112a, 112b, 112c, 212.

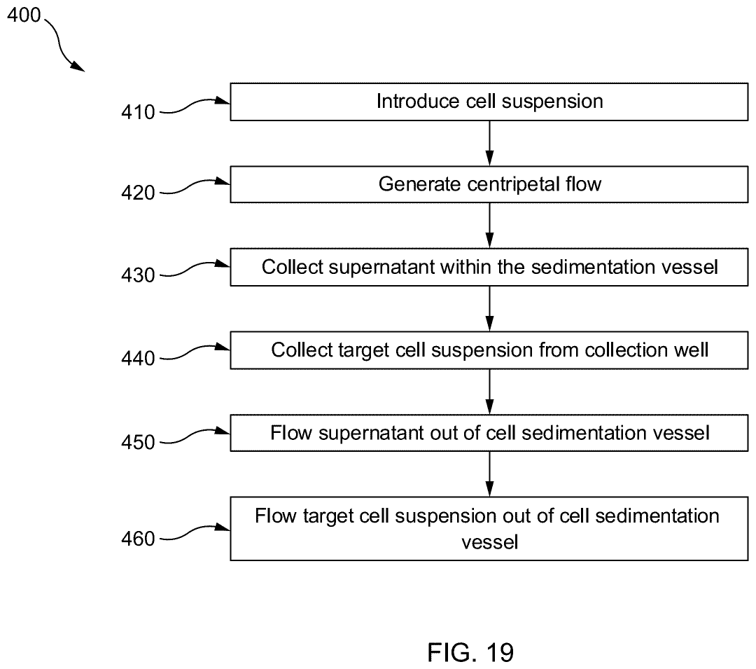

Further provided herein is a method 400 for collecting a target cell suspension from a cell suspension, as illustrated in the flow chart of FIG. 19. As should be understood herein, the method may be performed by the cell sedimentation system 100 and any of the previously described embodiments of the cell sedimentation module. The method 400 may further be implemented with the automated cell processing system or cell engineering system as previously described herein. Furthermore, the method 400 may not be limited solely to the described steps 410/420/430/440/450/460, and may include additional steps or fewer steps to achieve collection of a sedimentation or a target cell suspension from a cell suspension, as further described below.

The method 400 may include the step 410 of introducing the cell suspension. In embodiments, step 410 may include introducing the primary flow or the cell suspension into a cell sedimentation vessel via a first flow line. The cell sedimentation vessel may be any of the previously described embodiments of the cell sedimentation vessel 112/112′/112a/112b/112c/212/212a/212b/212c/300/510.

The method 400 may further include the step 420 of generating a centripetal flow. In embodiments, the step 420 may include generating the centripetal flow within any of the previously described embodiments of the cell sedimentation vessel 112/112′/112a/112b/112c/212/212a/212b/212c/300/510. Generating the centripetal flow within the cell sedimentation vessel may be to facilitate separation of the cell suspension into a supernatant and the target cell suspension for collection. The centripetal flow may be caused by the forces generated upon introduction of the primary flow or the cell suspension into the cell sedimentation vessel embodiments via the first flow line. Generating the centripetal flow may further include creating a primary vortex via the input of the primary flow or the cell suspension, decreasing pressure on the outside of the primary vortex, and increasing pressure on the inside of the primary vortex. Decreasing the pressure on the outside of the primary vortex may further be caused by frictional forces acting upon the swirling fluid, the frictional forces being generated by the fluid contacting the sidewalls and the bottom surfaces of the cell sedimentation vessel as it swirls or roils. Generating the centripetal flow may further include generating a secondary flow which moves settled sediment, particles, and/or cells toward an axial center of the cell sedimentation vessel, and/or towards the cell collection well.

The method 400 may further include the step 430 of collecting the supernatant. In embodiments, the step 430 may include collecting the supernatant near a bottom surface of any of the previously described embodiments of the cell sedimentation vessel 112/112′/112a/112b/112c/212/212a/212b/212c/300/510. Collecting the supernatant may further include sucking up the supernatant from the cell sedimentation vessel via the first flow line, using a vacuum. The supernatant may be the fluid or liquid flowing on top of sediment and/or target cells that collect on the bottom surface of the cell sedimentation vessel via the secondary flow generated by the centripetal flow.

The method 400 may further include the step 440 of collecting the sediment or the target cell suspension. In embodiments, the step 440 may include collecting the sediment or the target cell suspension in a collection well formed in the bottom surface of any of the previously described embodiments of the cell sedimentation vessel 112/112′/112a/112b/112c/212/212a/212b/212c/300/510. Collecting the sediment or the target cell suspension may further include forcing the sediment down into the cell collection well via the secondary flow formed by the centripetal flow occurring within the cell sedimentation vessel. Collecting the sediment or the target cell suspension may further include sucking up the sediment or the target cell collection from the cell sedimentation vessel via the second flow line, using a vacuum.

The method 400 may further include the step 450 of flowing the supernatant out of the cell sedimentation vessel. In embodiments, the step 450 may include flowing the supernatant out of the cell sedimentation vessel via the first flow line.

The method 400 may further include the step 460 of flowing the target cell suspension out of the cell sedimentation vessel. In embodiments, the step 460 may include flowing the target cell suspension collected in the collection well out of any of the previously described embodiments of the cell sedimentation vessel 112/112′/112a/112b/112c/212/212a/212b/212c/300/510 via a second flow line.

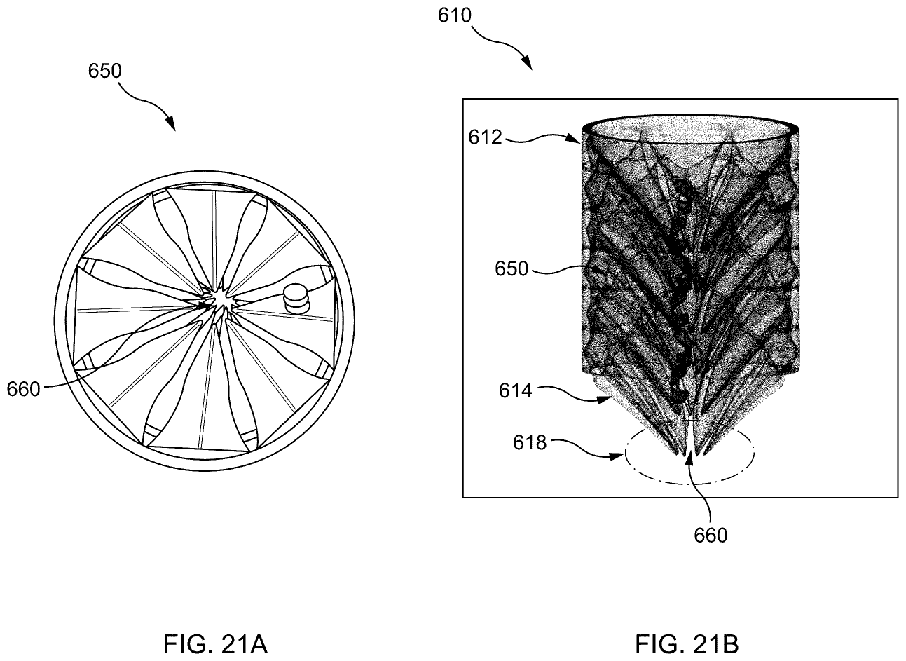

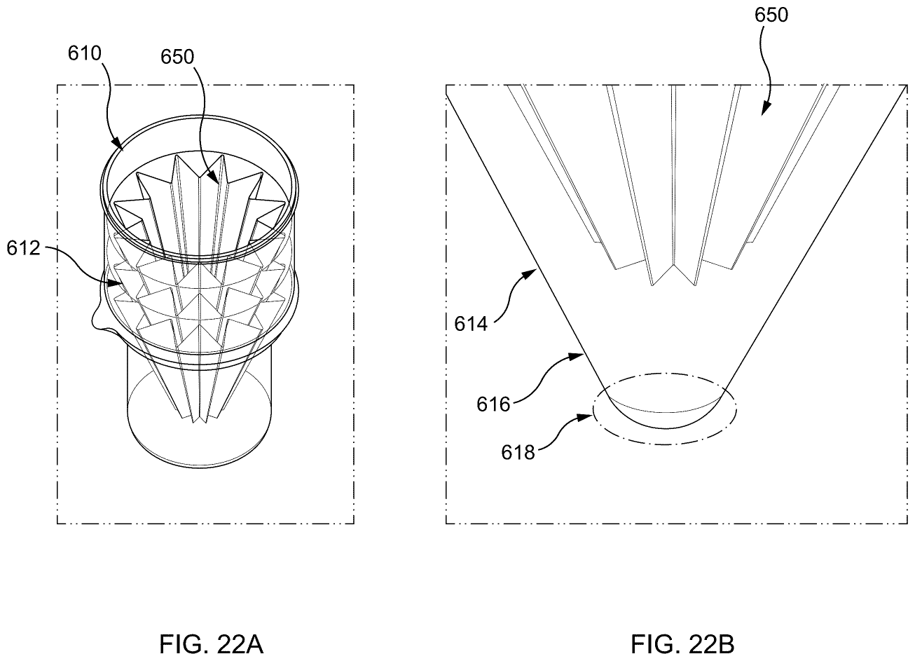

FIGS. 21A-22B illustrate an insert 650 configured for insertion into embodiments of a cell sedimentation module 610. The insert 650 may be a folded, patterned material sized and configured to fit within a cell sedimentation vessel 612, where once inserted, the insert 650 tapers or funnels inward at a downward angle towards a cell collection well 618. The insert 650 comprises an opening 660 formed at the tapering end of the insert for the passage of primary flow, sediment and/or supernatant during a separation procedure. More particularly, the insert 650 tapers inward at an angle corresponding to the inwardly-taping sidewalls 614 and bottom surface 616 of the cell sedimentation vessel 612. In embodiments, the insert 650 may be a 3D printed pattern. Alternatively, the insert 650 may be a folded sheet of a filtration material, plastic, polymer, or other material suitable for use with automated cell processing systems or cell engineering systems. The insert 650 may be folded in a scales style, a Leporello style, or an accordion-pleat style as shown in FIGS. 21A-22B. It should be understood by those having ordinary skill in the art that other folded configurations may be used as an insert, and that the configurations of the inserts are not limited to the embodiments described herein and shown in the figures.

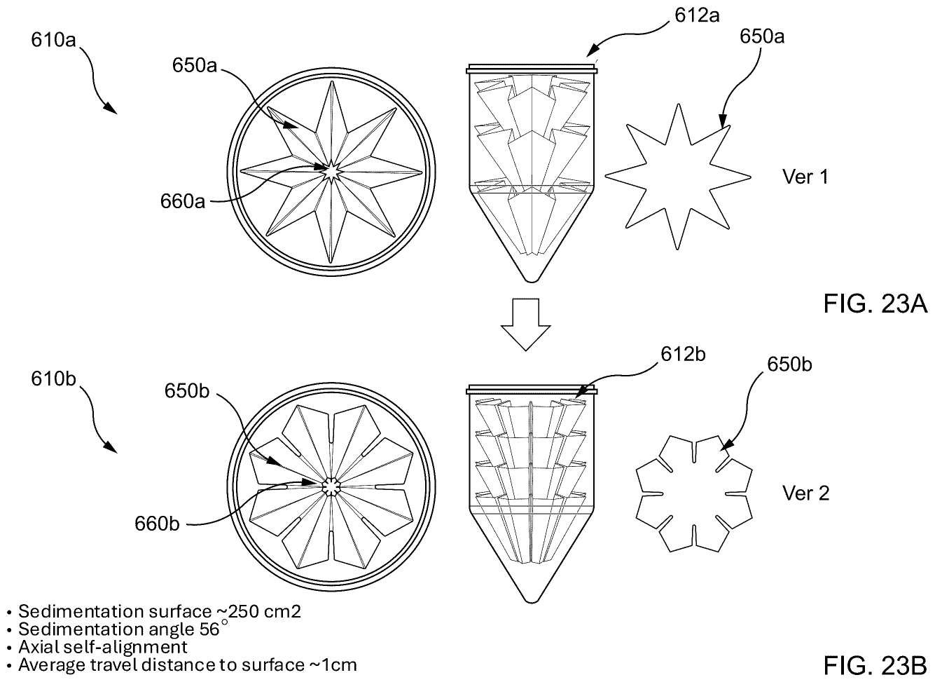

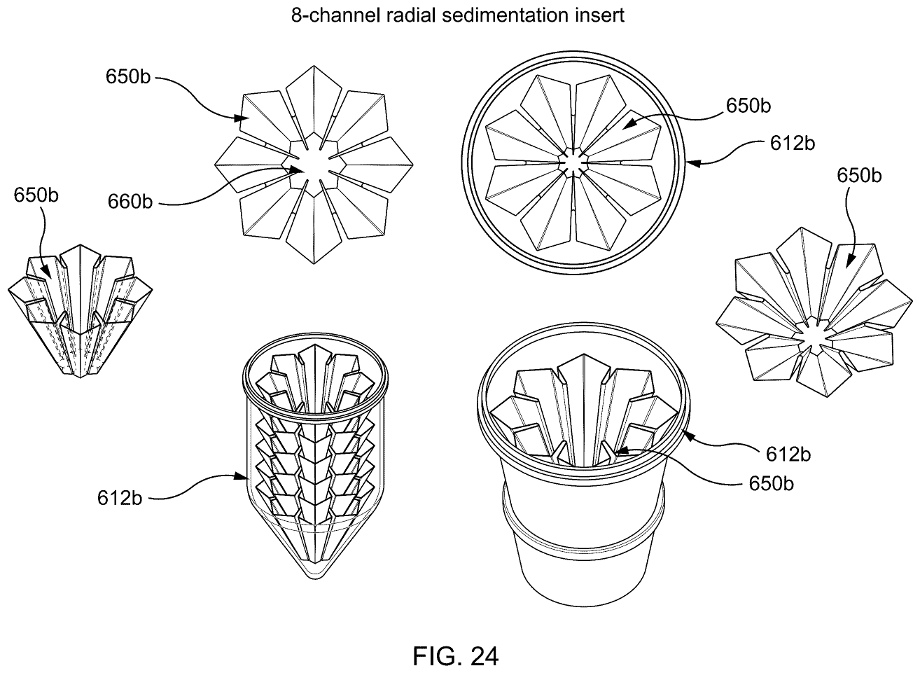

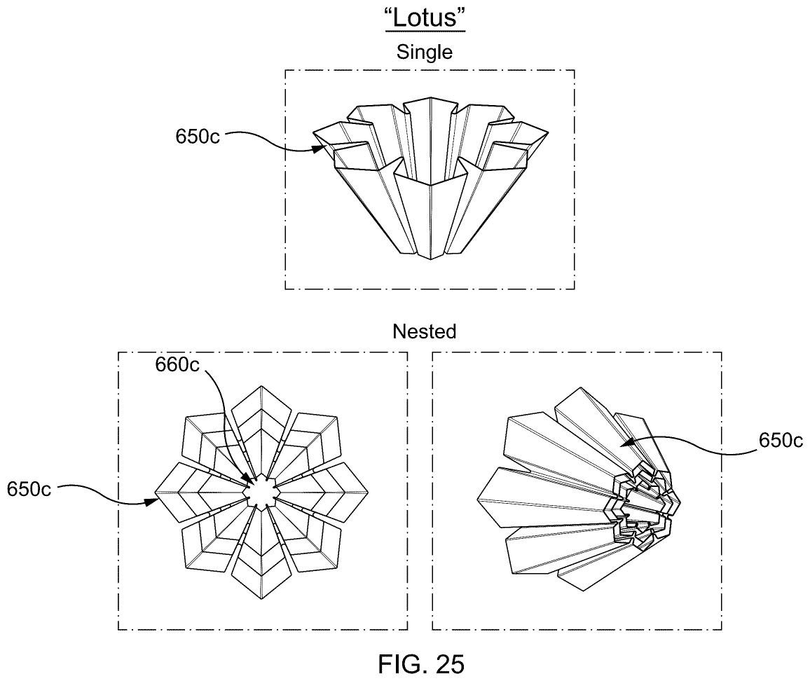

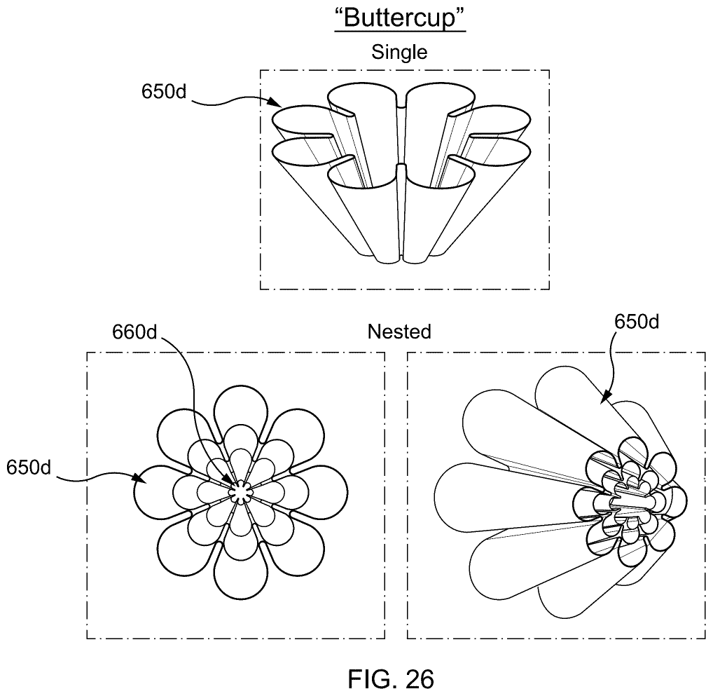

FIGS. 23A-26 illustrates embodiments of an insert 650a, 650b that are similarly configured for insertion into the cell sedimentation vessel 612a, 612b of the cell sedimentation module 610a, 610b. In embodiments, the insert 650a is formed as an eight-sided folded sheet or 3D printed pattern, having a profile in the shape of a star (i.e., with triangular pointed ends). In embodiments, the insert 650b is formed as an eight-sided folded sheet or 3D printed pattern, having a profile in the shape of a snowflake (i.e., with pentagon-like ends). In embodiments, the insert 650c is formed as an eight-sided folded sheet or 3D printed pattern, having a profile in the shape of a lotus. In embodiments, the insert 650d is formed as an eight-sided folded sheet or 3D printed pattern, having a profile in the shape of a buttercup. The inserts 650a, 650b, 650c, 650d folded in this manner create eight channels traversing downwards along its folded ends, in the direction of the collection wells of the corresponding cell sedimentation vessel embodiments previously described herein. The inserts 650a-650d comprise an opening 660a-660d formed at the tapering end of the insert for the passage of primary flow, sediment and/or supernatant during a separation procedure. As demonstrated across the embodiments of the insert 650, 650a-d, the insert can be folded in a variety of different patterns that results in eight channels configured for the flow of primary flow, and to further facilitate the separation of sediment and supernatant within the cell sedimentation vessels in which the insert 650, 605a-d is disposed therein. The folded configuration of these inserts 650, 650a-650d further facilitate axial alignment in embodiments where multiple inserts 650, 650a-650d are inserted or disposed within a single cell sedimentation vessel. The inserts 650, 650a-650d may further comprise a sedimentation surface area of approximately 250 cm².

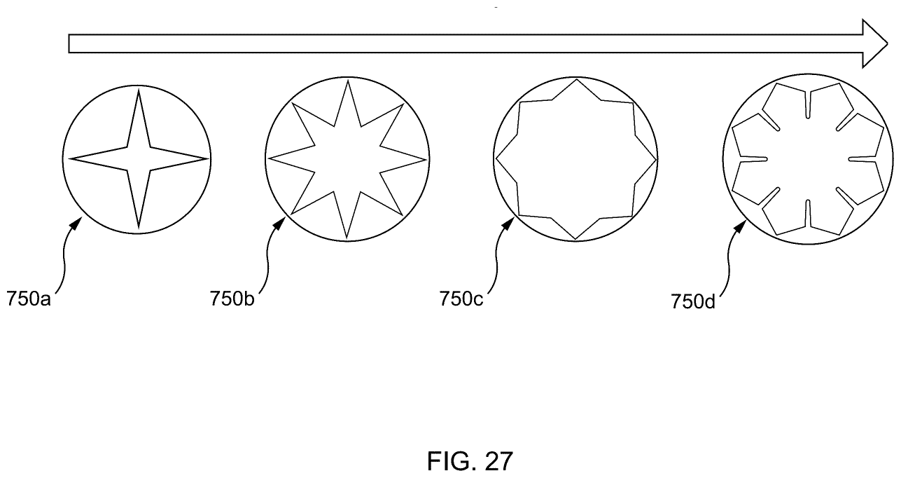

FIG. 27 illustrates further embodiments of inserts 750a-750d that may be incorporated into the embodiments of cell sedimentation vessels used in cell sedimentation modules previously described herein. In particular, it is shown that different folds or molds of the inserts may be used to achieve varying levels of surface coverage, available channels, air removal efficiency, and stackability of multiple inserts within the cell sedimentation vessel. As demonstrated by the arrow in FIG. 27, it is found that the varying levels of surface coverage, available channels, air removal efficiency, and stackability of multiple inserts iteratively increases from insert 750a up to 750d (i.e., with the aforementioned variables improving from 750a to 750b, from 750b to 750c, and from 750c to 750d). As illustrated in the embodiments depicted in FIGS. 21A-27, the various inserts 650, 650a, 650b, 650c, 650d, 750a, 750b, 750c, 750d may be folded into a four-channel pattern (i.e., the folds each creating a channel), or an eight-channel pattern. It should be understood by those having ordinary skill in the art that the inserts may further be folded into any number of channel patterns, including two, four, six, eight, ten, twelve, or more.

As should be understood by a person having ordinary skill in the art, the various embodiments of the insert 650, 650a-d, 750a-d described herein are sized and dimensioned to fit within any of the previously described embodiments of cell sedimentation vessels 112, 112′, 112a-112c described herein, including the multi-layered sedimentation module embodiments previously described above. For example, the various embodiments of the insert 650, 650a-d, 750a-d may be inserted or disposed within at least one, or all layers 212a-212c of sedimentation module 210, or within at least one, or all layers 512a-512c of sedimentation module 510. In embodiments, multiple inserts 650, 650a-d, 750a-d may be inserted into the same cell sedimentation vessel in a stacked configuration. In one embodiment, the multiple stacked inserts 650, 650a-d, 750a-d may all be inserts comprising the same or substantially similar profiles, number of channels, available surface area, etc., as exemplified in FIGS. 21B-26. In another embodiment, the multiple stacked inserts 650, 650a-d, 750a-d may be comprised of inserts with different profiles, number of channels, available surface areas, etc. For example, a cell sedimentation vessel may have one of each type of insert 650, 650a-d, 750a-d disposed therein. It should be understood that this is but one example, and that any embodiment of multiple stacked inserts is possible with any combination and/or number of inserts 650, 650a-d, 750a-d previously described herein. In embodiments, the inserts 650, 650a-d, 750a-d may be folded and inserted into the cell sedimentation vessel such that the channels formed by the folds of the insert are disposed at approximately a 30 to 60 degree angle with respect to the vertical axis of the sedimentation vessel. In embodiments, the channels formed by the folds of the insert are disposed at approximately a 30 to 45 degree angle with respect to the vertical axis of the sedimentation vessel.

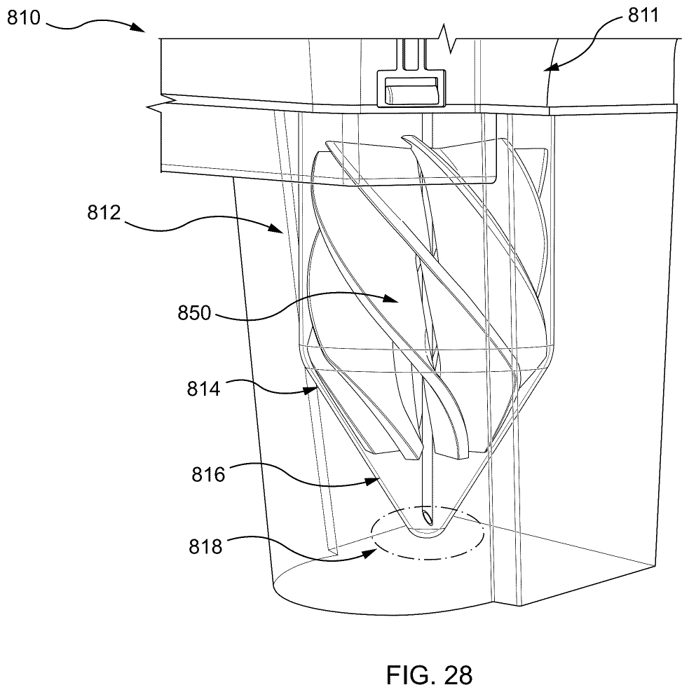

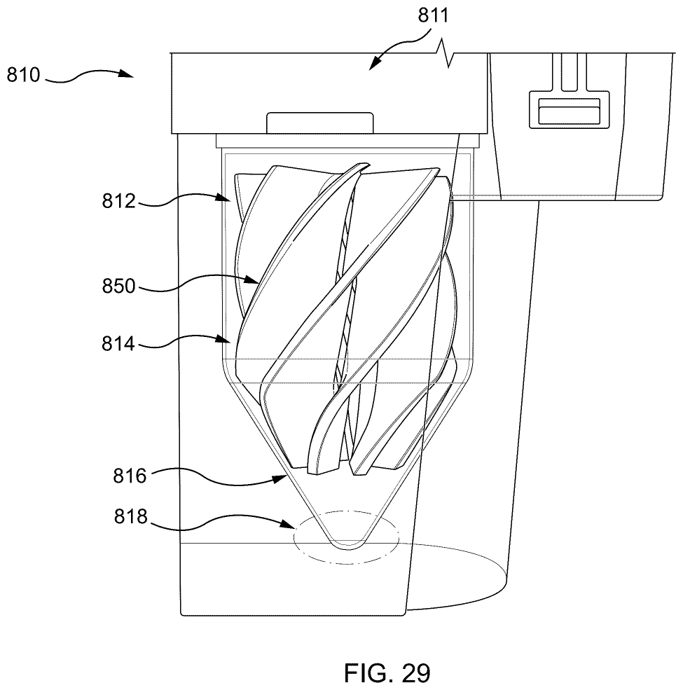

FIGS. 28-30C illustrate an embodiment of a cell sedimentation module 810 configured to receive a helical insert 850 therein. Cell sedimentation module 810 includes a housing 811 having a cell sedimentation vessel 812 inside, the housing configured for attachment, connection, or incorporation with the automated cell processing systems or cell engineering systems as previously described above. The cell sedimentation vessel 812 is formed with sidewalls 814 connected to a bottom surface 816, with a cell collection well 818 formed into the bottom surface 816, configured for the collection of a sediment or target cell suspension as previously described herein. The bottom surface 816 of the cell sedimentation vessel 812 is formed at an angle. In other words, the sidewalls 814 angle or taper inward starting from the top of the cell sedimentation vessel 812 toward the bottom surface 816 to form the angled bottom surface 816, such that the cell collection well 818 is formed in the bottom surface 816 where the tapering sidewalls 814 connect. The cell sedimentation vessel 812 has the helical insert 850 inserted inside, i.e., within the sidewalls 814.

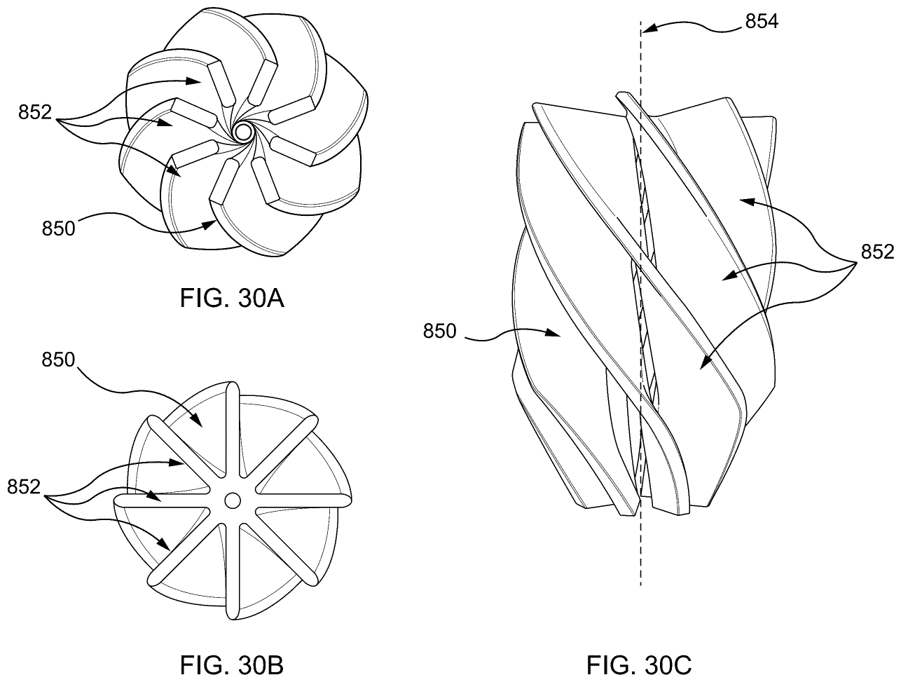

As illustrated in FIGS. 30A-30C, the helical insert 850 is formed by a plastic injection molded (e.g., 3D molded) or 3D printed piece comprising a plurality of sidewalls 852 uniformly wound around a shared central axis 854. The space between each wall 852 serves as channels for the flow of primary flow, sedimentation flow, and/or target cell suspension therethrough. The channels formed between each wall 852 facilitates the separation of a primary flow into sediment and supernatant as it flows through the space between each wall 852 into a direction downwards or towards the bottom surface 816 of the cell sedimentation vessel 812. In embodiments, the entire helical insert 850, or at least the walls 852 of the helical insert, may be 3D printed or molded in a manner where a layered micropattern is formed on its surface, such that the surface of the helical insert 850 and/or the walls 852 are not smooth, and may further facilitate the separation of primary flow into sediment and supernatant as it flows along the channels of the helical insert 850. Once the primary flow has passed through the cell sedimentation module 810 containing the helical insert 850 therein, and is separated into supernatant and sediment, the separated supernatant and sediment may be collected or removed from the cell sedimentation module 810 using various flow lines in fluid communication with the cell sedimentation module 810, as previously described herein with respect to the other cell sedimentation module embodiments.

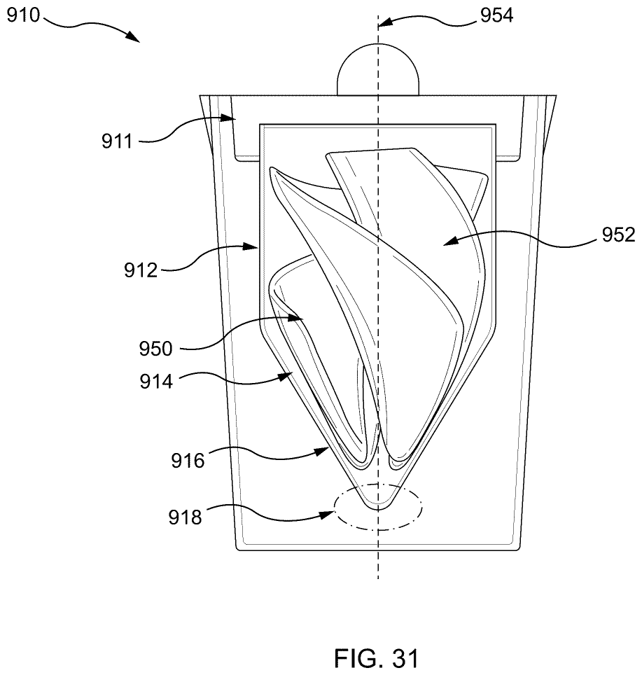

FIG. 31 illustrates another embodiment of a cell sedimentation module 910 configured to receive a spiral insert 950 therein. Cell sedimentation module 910 includes a housing 911 having a cell sedimentation vessel 912 inside, the housing configured for attachment, connection, or incorporation with the automated cell processing systems or cell engineering systems as previously described above. The cell sedimentation vessel 912 is formed with sidewalls 914 connected to a bottom surface 916, with a cell collection well 918 formed into the bottom surface 916, configured for the collection of a sediment or target cell suspension as previously described herein. The bottom surface 916 of the cell sedimentation vessel 912 is formed at an angle. In other words, the sidewalls 914 angle or taper inward starting from the top of the cell sedimentation vessel 912 toward the bottom surface 916 to form the angled bottom surface 916, such that the cell collection well 918 is formed in the bottom surface 916 where the tapering sidewalls 914 connect. The cell sedimentation vessel 912 has the spiral insert 950 inserted inside, i.e., within the sidewalls 914.

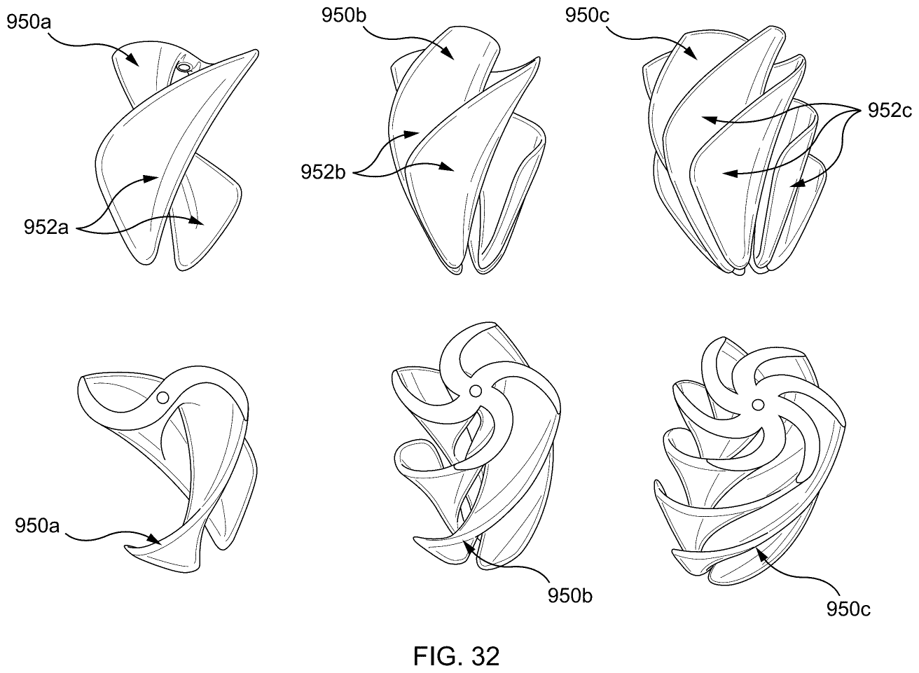

As illustrated in FIG. 31, the spiral insert 950 is formed by a plastic injection molded (e.g., 3D molded) or 3D printed piece comprising a plurality of sidewalls 952 uniformly wound around a shared central axis 954. The space between each wall 952 serves as channels for the flow of primary flow, sedimentation flow, and/or target cell suspension therethrough. FIG. 32 illustrates various embodiments of a spiral insert 950a, 950b, 950c, with each incremental embodiment having an increased number of sidewalls 952a, 952b, 952c. For example, spiral insert 950a is shown having two sidewalls 952a uniformly wound around its shared central axis, forming two channels. Spiral insert 950b is shown having four sidewalls 952b uniformly wound around its shared central axis, forming four channels. Spiral insert 950c is shown having six sidewalls 952c uniformly wound around its shared central axis, forming six channels. As the number of sidewalls 952a, 952b, 952c increases across the embodiments of the spiral inserts 950a, 950b, 950c, respectively, so does the number of available channels for the flow of primary flow, sedimentation flow, and/or target cell suspension therethrough. This increase in available sidewalls further increases the available surface area used to achieve separation of sediment from supernatant as the primary flow travels through the channels formed by the sidewalls 952a, 952b, 952c. The channels formed between each sidewall 952a-952c facilitates the separation of a primary flow into sediment and supernatant as it flows through the space between each wall 952a-952c into a direction downwards or towards the bottom surface 916 of the cell sedimentation vessel 912. In embodiments, the entire spiral insert 950a-950c, or at least the walls 952a-952c of the spiral insert, may be 3D printed or molded in a manner where a layered micropattern is formed on its surface, such that the surface of the spiral insert 950a-950c and/or the walls 952a-952c are not smooth, and may further facilitate the separation of primary flow into sediment and supernatant as it flows along the channels of the helical insert 950a-950c. once the primary flow has passed through the cell sedimentation module 910 containing the spiral insert 950a-950c therein, and is separated into supernatant and sediment, the separated supernatant and sediment may be collected or removed from the cell sedimentation module 910 using various flow lines in fluid communication with the cell sedimentation module 910, as previously described herein with respect to the other cell sedimentation module embodiments.

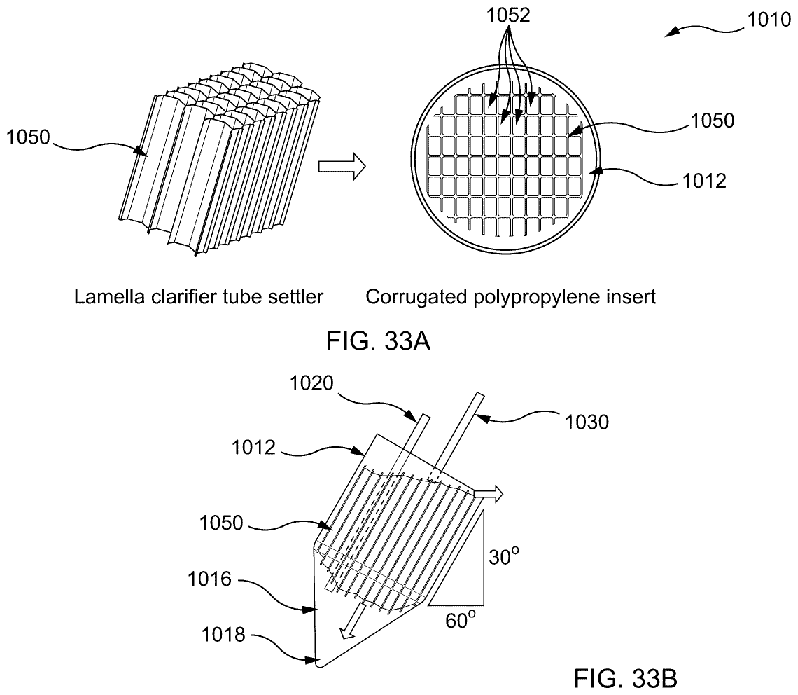

FIGS. 33A-33B illustrate another embodiment of a cell sedimentation module 1010 configured to receive a lamella insert 1050 therein. The lamella insert 1050 is formed by a plastic molded (e.g., 3D molded) piece formed as a grid or matrix from a top-down view, with sidewalls extending downwards in a parallel orientation, approximately of a length sufficient to fit the lamella insert 1050 fully within a cell sedimentation vessel 1012 or within embodiments of the cell sedimentation vessel previously described herein. The grid or matrix-like structure of the lamella insert 1050 creates a plurality of available parallel channels 1052 for the flow of primary flow, sedimentation flow, and/or target cell suspension therethrough. The amount of available surface area for the primary flow, sedimentation flow, and/or target cell suspension to contact as it travels through the plurality of channels is optimized by the structure of the lamella insert. A first flow line 1020 configured for the introduction of a primary flow may be disposed within the cell sedimentation vessel 1012, such that the first flow line 1020 runs through at least one of the channels 1052 of the lamella insert 1050 and ends past the insert 1050 at a position near the bottom surface 1016 of the cell sedimentation vessel 1012. A second flow line 1030 configured for the output of supernatant may be disposed within the cell sedimentation vessel 1012 or at the top surface of the cell sedimentation vessel 1012, such that the second flow line 1030 ends at a point before the lamella insert 1050 begins within the cell sedimentation vessel 1012.

The lamella insert 1050 achieves improved settlement of sediment from supernatant within the cell sedimentation module 1010 through the use of the lamella particle settler effect. That is, the angled, parallel orientations of the channels 1052 achieve an increase in settling speed of sediment (separated from supernatant) after a primary flow is introduced into the cell sedimentation module 1010, due to the increased surface area and angles provided by the channels 1052 of the lamella insert 1050. When the primary flow is introduced into the cell sedimentation module 1010 via the first flow line 1020, it is introduced at a position below the lamella insert 1050. The flow caused by this input results in energy being dissipated around this input area (i.e., below the lamella insert 1050). The primary flow will continue to underflow beneath the lamella insert 1050, where it becomes evenly distributed to the channels 1052. Sediment may then collect within the channels 1052 and begin to slide back down the channels 1052 due to their angles, eventually collecting within the collection well 1018. Meanwhile, supernatant flows or travels up the channels 1052 of the lamella insert 1050, eventually collecting at a position within the upper portions of the lamella insert 1050 or above the lamella insert 1050 within the cell sedimentation vessel 1012, where it is then extracted via the second flow line 1030. The sediment collected in the collection well 1018 may then later be extracted via the primary flow line 1020, a separate extraction flow line (not shown), or by other extraction means, and provided to the automated cell processing system or cell engineering system for further processing.

Settlement of sediment in the embodiments of collection wells of cell sedimentation vessels utilizing the lamella insert previously described herein may be calculated through the use of the Hazen formula:

$$\frac{Vs}{H} > \frac{Q}{( L \times W \times H )}$$

where:
Vs is fluid velocity;
Q is flow rate;
H is the height of the channels of the lamella insert; and
L×W×H represents the area (A) of the lamella insert; i.e. the length, width, and height of the lamella insert.

With the embodiments of the cell sedimentation modules previously described herein, it was found that sediment and/or target cell particles could settle within the collection wells of the sedimentation vessels in events where Vs divided by H was larger in value than Q divided by A (or L×W×H). The smaller the value of Vs divided by H, the less likely particle settlement would occur.

Furthermore, the angle of the channels 1052 of the lamella insert with respect to the vertical axis of the cell sedimentation vessel is correlated to optimized particle settlement. As shown in FIG. 33B, it was determined that the lamella insert 1050 may be inserted into the cell sedimentation vessels such that the angle of the channels 1052 is approximately 55-60% from the horizontal plane of the lamella insert 1050 for cell-like particles. Alternatively, the optimized angle can be achieved by tilting the sedimentation vessel itself within the cell sedimentation module.

The inserts 650, 650a-650d, 750a-750d, 850, 950, 950a-950c, 1050 previously described herein provide the unexpected benefit of drastically reducing sedimentation recovery time for a desired percentage of sediment present in primary flows introduced into the embodiments of the cell sedimentation modules previously described. In particular, it was discovered that the use of the inserts 650, 650a-650d, 750a-750d, 850, 950, 950a-950c, 1050 in the embodiments of the cell sedimentation vessels previously described resulted in an approximately 60% recovery of sediment present in a primary flow over a period of about two hours-a substantial improvement from prior sediment collection procedures which typically take up to 6-7 hours to achieve the same recovery percentage. The unexpected benefit achieved from this reduced sediment recovery time lies in the ability to improve transfection efficiency of the sediment collected, as the length of settlement time is inversely related to transfection efficiency (i.e., lower efficiencies result from longer settlement times).

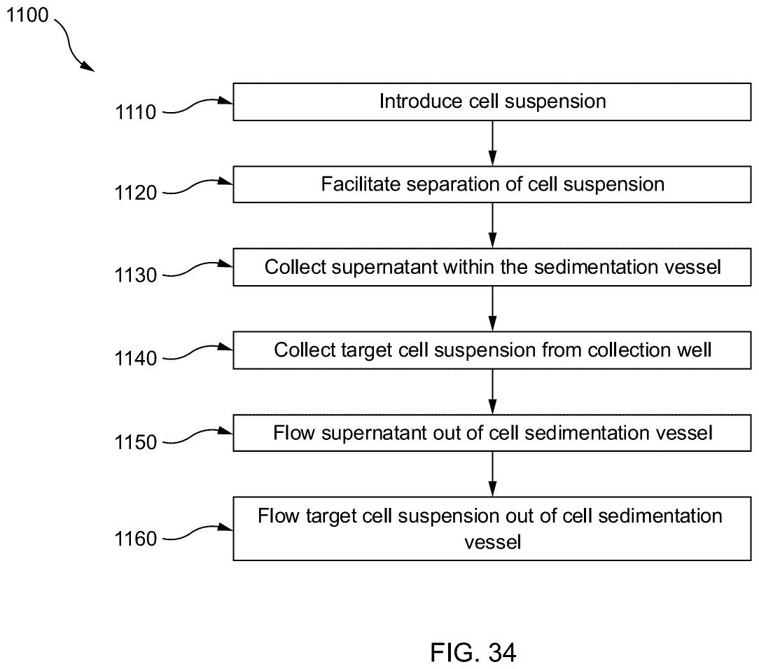

Further provided herein is a method 1100 for collecting a target cell suspension from a cell suspension, as illustrated in the flow chart of FIG. 34. As should be understood herein, the method may be performed by the cell sedimentation system 100 and any of the previously described embodiments of the cell sedimentation module. The method 400 may further be implemented with the automated cell processing system or cell engineering system as previously described herein. Furthermore, the method 400 may not be limited solely to the described steps 1110/1120/1130/1140/1150/1160, and may include additional steps or fewer steps to achieve collection of a sedimentation or a target cell suspension from a cell suspension, as further described below.

The method 1100 may include the step 1110 of introducing the cell suspension. In embodiments, step 1110 may include introducing the primary flow or the cell suspension into a cell sedimentation vessel via a first flow line. The cell sedimentation vessel may be any of the previously described embodiments of the cell sedimentation vessel 612/612a/612b/812/912/1012.

The method 1100 may further include the step 1120 of facilitating separation of the cell suspension. In embodiments, the step 1120 may include facilitating the separation of the cell suspension into supernatant and sediment within any of the previously described embodiments of the cell sedimentation vessel 612/612a/612b/812/912/1012. Facilitating the separation of the cell suspension within the cell sedimentation vessel may be to facilitate separation of the cell suspension into a supernatant and the target cell suspension for collection and/or further processing using the automated cell processing system or cell engineering system as previously described herein. The facilitation of separation of the cell suspension may be achieved through the cell suspension flowing through the inserts 650/650a/650b/650c/650d/750a/750b/750c/750d/850/950/950a/950b/950c/1050 and separating in the manner described with respect to the various inserts previously described herein. Facilitating the separation of the cell suspension may further include increasing the surface areas contacting the cell suspension as it flows through the inserts 650/650a/650b/650c/650d/750a/750b/750c/750d/850/950/950a/950b/950c/1050 disposed within the cell sedimentation vessels as previously described herein.

The method 1100 may further include the step 1130 of collecting the supernatant. In embodiments, the step 1130 may include collecting the supernatant near a bottom surface of any of the previously described embodiments of the cell sedimentation vessel 612/612a/612b/812/912/1012. Collecting the supernatant may further include sucking up the supernatant from the cell sedimentation vessel via the first flow line, using a vacuum. The supernatant may be the fluid or liquid flowing on top of sediment and/or target cells that collect on the bottom surface of the cell sedimentation vessel via the separation facilitated from the cell suspension contacting the increased surface areas created by the inserts 650/650a/650b/650c/650d/750a/750b/750c/750d/850/950/950a/950b/950c/1050 disposed within the cell sedimentation vessels.

The method 1100 may further include the step 1140 of collecting the sediment or the target cell suspension. In embodiments, the step 1140 may include collecting the sediment or the target cell suspension in a collection well formed in the bottom surface of any of the previously described embodiments of the cell sedimentation vessel 612/612a/612b/812/912/1012. Collecting the sediment or the target cell suspension may further include forcing the sediment down into the cell collection well via a particle settler effect occurring within the cell sedimentation vessel having the inserts 650/650a/650b/650c/650d/750a/750b/750c/750d/850/950/950a/950b/950c/1050 disposed within the cell sedimentation vessels. Collecting the sediment or the target cell suspension may further include sucking up the sediment or the target cell collection from the cell sedimentation vessel via the second flow line, using a vacuum.

The method 1100 may further include the step 1150 of flowing the supernatant out of the cell sedimentation vessel. In embodiments, the step 1150 may include flowing the supernatant out of the cell sedimentation vessel via the first flow line.

The method 1100 may further include the step 1160 of flowing the target cell suspension out of the cell sedimentation vessel. In embodiments, the step 1160 may include flowing the target cell suspension collected in the collection well out of any of the previously described embodiments of the cell sedimentation vessel 612/612a/612b/812/912/1012 via a second flow line.

It will be apparent to one of ordinary skill in the relevant arts that other suitable modifications and adaptations to the systems, devices, and methods described herein can be made without departing from the scope of any of the embodiments. The embodiments described above are illustrative examples and it should not be construed that the present disclosure is limited to those particular embodiments. It should be understood that various embodiments disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the methods or processes). In addition, while certain features of embodiments hereof are described as being performed by a single component, module, or unit for purposes of clarity, it should be understood that the features and functions described herein may be performed by any combination of components, units, or modules. Thus, various changes and modifications may be affected by one skilled in the art without departing from the spirit or scope of the invention as defined in the appended claims.

### Examples

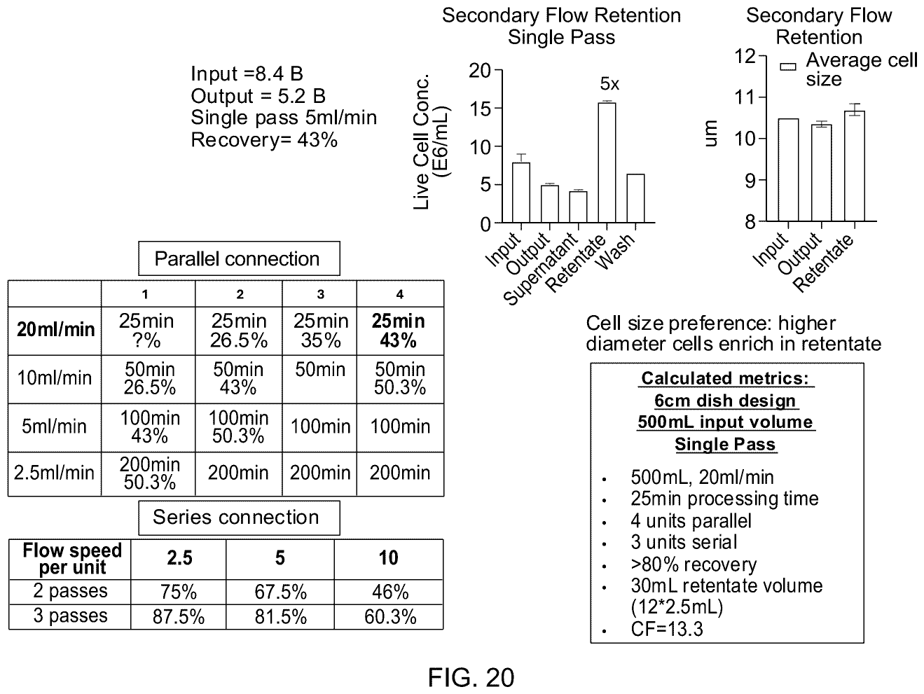

FIG. 20 provides test results measuring secondary flow retention using embodiments of the cell sedimentation vessel (as illustrated in FIGS. 2B and 8A-8B, for example) and methods described herein. In particular, the data presented in FIG. 20 illustrates improved volume reduction, cell concentration, washing, and supernatant separation capabilities in connection with automated cell expansion and processing applications utilizing the cell sedimentation vessels and methods described herein. FIG. 20 further illustrates target cell recovery percentages in systems where multiple cell sedimentation vessels are connected in parallel versus in series. In particular, it was shown that parallel connection of multiple cell sedimentation vessels resulted in an increase in throughput (i.e., higher cumulative flow rate in milliliters per minute). Alternatively, a series connection of multiple cell sedimentation vessels (e.g., related to the number of passes therethrough) results in an increase in overall recovery percentage (i.e., retention efficiency).

### Embodiments

In embodiments, provided herein is:
Embodiment 1. A cell sedimentation module comprising: a housing; a cell sedimentation vessel disposed within the housing, the cell sedimentation vessel having sidewalls, a bottom surface, and a cell collection well formed into the bottom surface; a first flow line configured for input of a cell suspension and output of a supernatant; and a second flow line configured for output of a target cell suspension; wherein the cell sedimentation vessel is configured to non-mechanically generate a centripetal flow therein to facilitate separation of the supernatant and the target cell suspension from the cell suspension.
Embodiment 2. The cell sedimentation module of embodiment 1, wherein the bottom surface of the cell sedimentation vessel is substantially planar to facilitate generating the centripetal flow.
Embodiment 3. The cell sedimentation module of embodiment 1, wherein the bottom surface of the cell sedimentation vessel is formed at an angle to facilitate generating the centripetal flow.
Embodiment 4. The cell sedimentation module of embodiment 1, wherein the second flow line is disposed substantially along a vertical axis of the cell sedimentation vessel.
Embodiment 5. The cell sedimentation module of embodiment 1 wherein the first flow line is disposed off-center from a vertical axis of the cell sedimentation vessel.
Embodiment 6. The cell sedimentation module of embodiment 1, wherein the first flow line includes a first flow line end disposed near the bottom surface of the cell sedimentation vessel, and the first flow line end is angled with respect to the first flow line.
Embodiment 7. The cell sedimentation module of embodiment 6, wherein the first flow line end includes a valve controlled input section, and a valve controlled output section.
Embodiment 8. The cell sedimentation module of embodiment 7, wherein the first flow line end includes a fluid filter integrated within the first flow line end.
Embodiment 9. The cell sedimentation module of embodiment 1, wherein the bottom surface of the cell sedimentation vessel includes a silicone lining.
Embodiment 10. A sedimentation system, comprising: a cell sedimentation module having a housing for containing a cell sedimentation vessel therein, the cell sedimentation vessel having sidewalls, a bottom surface, and a cell collection well formed into the bottom surface; a first flow line configured for input flow of a cell suspension into the cell sedimentation vessel and output flow of a supernatant from the cell sedimentation vessel, wherein the input flow non-mechanically generates a centripetal flow within the cell sedimentation vessel to facilitate separation of the cell suspension into the supernatant on the bottom surface and a target cell suspension in the cell collection well; and a second flow line configured for output flow of the target cell suspension collected in the cell collection well of the cell sedimentation vessel.
Embodiment 11. The sedimentation system of embodiment 10, wherein the bottom surface of the cell sedimentation vessel is substantially planar to facilitate generating the centripetal flow.
Embodiment 12. The sedimentation system of embodiment 10, wherein the bottom surface of the cell sedimentation vessel is formed at an angle to facilitate generating the centripetal flow.
Embodiment 13. The sedimentation system of embodiment 10, wherein the second flow line is disposed substantially along a vertical axis of the cell sedimentation vessel.
Embodiment 14. The sedimentation system of embodiment 10, wherein the first flow line is disposed off-center from a vertical axis of the cell sedimentation vessel.
Embodiment 15. The sedimentation system of embodiment 10 wherein the first flow line includes a first flow line end disposed near the bottom surface of the cell sedimentation vessel, and the first flow line end is angled with respect to the first flow line.
Embodiment 16. The sedimentation system of embodiment 15, wherein the first flow line end includes a valve controlled input section, and a valve controlled output section.
Embodiment 17. The sedimentation system of embodiment 16, wherein the first flow line end includes a fluid filter integrated within the first flow line end.
Embodiment 18. The sedimentation system of embodiment 10, wherein the bottom surface of the cell sedimentation vessel includes a silicone lining.
Embodiment 19. A method for collecting a target cell suspension from a cell suspension, comprising: introducing the cell suspension into a cell sedimentation vessel via a first flow line; generating a centripetal flow within the cell sedimentation vessel to facilitate separation of the cell suspension into a supernatant and the target cell suspension; collecting the supernatant near a bottom surface of the cell sedimentation vessel; collecting the target cell suspension in a collection well formed in the bottom surface of the cell sedimentation vessel; flowing the supernatant out of the cell sedimentation vessel via the first flow line; and flowing the target cell suspension collected in the collection well out of the cell sedimentation vessel via a second flow line.
Embodiment 20. A cell sedimentation module comprising: a housing; a multi-level cell sedimentation vessel disposed within the housing, the multi-level cell sedimentation vessel including a plurality of vessels sequentially oriented related to each other, each of the plurality of vessels having sidewalls, a bottom surface, and a cell collection well formed into the bottom surface of at least one of the plurality of vessels; at least one first flow line configured for input of a cell suspension into at least one of the plurality of vessels, and output of a supernatant from at least one of the plurality of vessels; and at least one second flow line configured for output of a target cell suspension from the cell collection well formed into the bottom surface of the at least one of the plurality of vessels.
Embodiment 21. The cell sedimentation module of embodiment 20, wherein the cell collection well is formed into the bottom surface of a final, sequential vessel.
Embodiment 22. The cell sedimentation module of embodiment 20, wherein the cell collection well is formed into the bottom surface of each of the plurality of vessels.
Embodiment 23. A cell sedimentation module comprising: a housing; a cell sedimentation vessel disposed within the housing, the cell sedimentation vessel having sidewalls, a bottom surface, and a cell collection well formed into the bottom surface; a press filter disposed within the cell sedimentation vessel, the press filter having a substantially conical shape with a plurality of openings disposed thereon to allow for flow of a cell suspension therethrough; a first flow line configured for input of the cell suspension and output of a supernatant; and a second flow line configured for output of a target cell suspension; wherein the cell sedimentation vessel and the press filter are configured to non-mechanically generate a centripetal flow therein to facilitate separation of the supernatant and the target cell suspension from the cell suspension.
Embodiment 24. A cell sedimentation module comprising: a housing; a cell sedimentation vessel disposed within the housing, the cell sedimentation vessel having sidewalls, a bottom surface, and a cell collection well formed into the bottom surface; an insert disposed within the cell sedimentation vessel; and wherein the insert facilitates separation of a supernatant and a target cell suspension from a cell suspension.
Embodiment 25. The cell sedimentation module of embodiment 24, wherein the insert is a plastic molded or 3D molded structure.
Embodiment 26. The cell sedimentation module of embodiment 25, wherein the insert is a helical insert.
Embodiment 27. The cell sedimentation module of embodiment 25, wherein the insert is a spiral insert.
Embodiment 28. The cell sedimentation module of embodiment 25, wherein the insert is a lamella insert.
Embodiment 29. The cell sedimentation module of embodiment 24, wherein the insert is a folded sheet or 3D printed structure.
Embodiment 30. The cell sedimentation module of embodiment 29, wherein the insert is folded into a four-channel pattern.
Embodiment 31. The cell sedimentation module of embodiment 29, wherein the insert is folded into an eight-channel pattern.
Embodiment 32. The cell sedimentation module of embodiment 29, wherein the insert is folded into a scales profile, a lotus profile, a star profile, or a buttercup profile.
Embodiment 33. A method for collecting a target cell suspension from a cell suspension, comprising: inserting an insert into a cell sedimentation vessel; introducing the cell suspension into the cell sedimentation vessel via a first flow line; facilitating separation of the cell suspension into a supernatant and the target cell suspension by flowing the cell suspension over a surface of the insert within the cell sedimentation vessel; collecting the supernatant within the cell sedimentation vessel; settling the target cell suspension in a collection well formed in a bottom surface of the cell sedimentation vessel; flowing the supernatant out of the cell sedimentation vessel via the first flow line; and flowing the target cell suspension collected in the collection well out of the cell sedimentation vessel via a second flow line.
Embodiment 34. The method of embodiment 33, wherein the step of facilitating separation of the cell suspension is achieved via a lamella particle settler effect.
Embodiment 35. The method of embodiment 33, wherein settling the target cell suspension in the collection well may be calculated through use of the Hazen formula:

$$\frac{Vs}{H} > \frac{Q}{( L \times W \times H )}$$

where: Vs is fluid velocity; Q is flow rate; H is a height of channels of the insert; and L×W×H represents an area (A) of the insert.

1. A cell sedimentation module comprising:
a housing;
a cell sedimentation vessel disposed within the housing, the cell sedimentation vessel having sidewalls, a bottom surface, and a cell collection well formed into the bottom surface;
a first flow line configured for input of a cell suspension and output of a supernatant; and
a second flow line configured for output of a target cell suspension;
wherein the cell sedimentation vessel is configured to non-mechanically generate a centripetal flow therein to facilitate separation of the supernatant and the target cell suspension from the cell suspension.

2. The cell sedimentation module of claim 1, wherein the bottom surface of the cell sedimentation vessel is substantially planar to facilitate generating the centripetal flow.

3. The cell sedimentation module of claim 1, wherein the bottom surface of the cell sedimentation vessel is formed at an angle to facilitate generating the centripetal flow.

4. The cell sedimentation module of claim 1, wherein the second flow line is disposed substantially along a vertical axis of the cell sedimentation vessel.

5. The cell sedimentation module of claim 1 wherein the first flow line is disposed off-center from a vertical axis of the cell sedimentation vessel.

6. The cell sedimentation module of claim 1, wherein the first flow line includes a first flow line end disposed near the bottom surface of the cell sedimentation vessel, and the first flow line end is angled with respect to the first flow line.

7. The cell sedimentation module of claim 6, wherein the first flow line end includes a valve controlled input section, and a valve controlled output section.

8. The cell sedimentation module of claim 7, wherein the first flow line end includes a fluid filter integrated within the first flow line end.

9. The cell sedimentation module of claim 1, wherein the bottom surface of the cell sedimentation vessel includes a silicone lining.

10. A cell sedimentation module comprising:
a housing;
a multi-level cell sedimentation vessel disposed within the housing, the multi-level cell sedimentation vessel including a plurality of vessels sequentially oriented related to each other, each of the plurality of vessels having sidewalls, a bottom surface, and a cell collection well formed into the bottom surface of at least one of the plurality of vessels;
at least one first flow line configured for input of a cell suspension into at least one of the plurality of vessels, and output of a supernatant from at least one of the plurality of vessels; and
at least one second flow line configured for output of a target cell suspension from the cell collection well formed into the bottom surface of the at least one of the plurality of vessels.

11. The cell sedimentation module of claim 10, wherein the cell collection well is formed into the bottom surface of a final, sequential vessel.

12. The cell sedimentation module of claim 10, wherein the cell collection well is formed into the bottom surface of each of the plurality of vessels.

13. A cell sedimentation module comprising:
a housing;
a cell sedimentation vessel disposed within the housing, the cell sedimentation vessel having sidewalls, a bottom surface, and a cell collection well formed into the bottom surface;
an insert disposed within the cell sedimentation vessel; and
wherein the insert facilitates separation of a supernatant and a target cell suspension from a cell suspension.

14. The cell sedimentation module of claim 13, wherein the insert is a plastic molded or 3D molded structure.

15. The cell sedimentation module of claim 14, wherein the insert is a helical insert.

16. The cell sedimentation module of claim 14, wherein the insert is a spiral insert.

17. The cell sedimentation module of claim 14, wherein the insert is a lamella insert.

18. The cell sedimentation module of claim 13, wherein the insert is a folded sheet or 3D printed structure.

19. The cell sedimentation module of claim 18, wherein the insert is folded into a four-channel pattern.

20. The cell sedimentation module of claim 18, wherein the insert is folded into an eight-channel pattern.

21. The cell sedimentation module of claim 18, wherein the insert is folded into a scales profile, a lotus profile, a star profile, or a buttercup profile.

22. A method for collecting a target cell suspension from a cell suspension, comprising:
inserting an insert into a cell sedimentation vessel;
introducing the cell suspension into the cell sedimentation vessel via a first flow line;
facilitating separation of the cell suspension into a supernatant and the target cell suspension by flowing the cell suspension over a surface of the insert within the cell sedimentation vessel;
collecting the supernatant within the cell sedimentation vessel;
settling the target cell suspension in a collection well formed in a bottom surface of the cell sedimentation vessel;
flowing the supernatant out of the cell sedimentation vessel via the first flow line; and
flowing the target cell suspension collected in the collection well out of the cell sedimentation vessel via a second flow line.

23. The method of claim 22, wherein the step of facilitating separation of the cell suspension is achieved via a lamella particle settler effect.

24. The method of claim 22, wherein settling the target cell suspension in the collection well may be calculated through use of the Hazen formula:
$$\frac{Vs}{H} > \frac{Q}{( L \times W \times H )}$$
where:
Vs is fluid velocity;
Q is flow rate;
H is a height of channels of the insert; and
L×W×H represents an area (A) of the insert.
